(19) United States
(12) Patent Application Publication
(10) Pub. No.: US 2025/0259549 A1
(43) Pub. Date: Aug. 14, 2025

(54) SYSTEMS AND METHODS FOR FLIGHT DATA CONTENT GENERATION

(71) Applicant: Fly Hangar, LLC, Buckley, WA (US)

(72) Inventor: Jay Samuel Sessler, Buckley, WA (US)

(21) Appl. No.: 18/653,749

(22) Filed: May 2, 2024

Related U.S. Application Data
(60) Provisional application No. 63/552,025, filed on Feb. 9, 2024.

(51) Int. Cl. G08G 5/00

(52) U.S. Cl. CPC G08G 5/20; G08G 5/55; G08G 5/59

(57) ABSTRACT

A flight data content generation system is described herein. The flight data content generation system receives an indication of an airplane associated with a user and receives flight data from at least one flight data repository based on the indicated airplane. The flight data content generation system identifies one or more airports based on the flight data and generates a flight path based on the identified airports, flight data, and indicated airplane. The flight data content generation system receives an indication of descriptive data regarding the flight path and causes a display to visually display a pattern showing an indication of the flight path and an indication of the descriptive data to a user. The flight data content generation system causes the flight path and the descriptive data to be transmitted to a second user device.

### CROSS REFERENCE TO RELATED APPLICATIONS

This patent application claims priority from U.S. provisional patent application Ser. No. 63/552,025 titled “SYSTEMS AND METHODS FOR FLIGHT DATA CONTENT GENERATION” filed on Feb. 9, 2024. For text and technical teachings in which the present application conflicts with a document incorporated by reference, the present application controls.

### BACKGROUND

Airplane pilots enjoy learning from, receiving information from, and otherwise interacting with other pilots. Such pilot interaction may include sharing flight paths, information regarding turbulence encountered, takeoff conditions, wind conditions, off-airport strips, airports, pilot flying skills, aircraft performance and types of aircraft, as well as interactions between pilots. It is with respect to this and other considerations that the embodiments described herein have been made.

### BRIEF DESCRIPTION

A system of one or more computers can be configured to permit pilots to post details of various flights they have taken, together with comments and data regarding each flight for others to view, comment on and learn from. This permits pilots to exchange data rapidly regarding flights, learn from each other and use information from another pilots flight in future flight they will be making.

The system will perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions. The system may include a display. The system may include at least one processor. The system may include at least one memory coupled to the at least one processor, the memory having computer-executable instructions stored thereon that, when executed by the at least one processor, cause the system to: receive an indication of an airplane associated with a user; receive an indication of flight data from one or more flight data repositories based on the indication of the indicated airplane; identify one or more airports based on the flight data; generate a flight path based on the identified one or more airports, the flight data, and the indicated airplane; receive an indication of descriptive data regarding the flight path; cause the display to visually display a pattern showing an indication of the flight path and an indication of the descriptive data to the user on a first user device; and cause the flight path and the descriptive data to be transmitted to a second user device. Other embodiments of this aspect include corresponding computer systems, apparatus, and computer programs recorded on one or more computer storage devices, each configured to perform the actions of the methods.

Implementations may include one or more of the following features. The computer-executable instructions may cause the flight path and descriptive data to be transmitted to the second user device. Implementations may further cause the system to transmit data indicating the flight path and the descriptive data to a server configured to distribute the flight path and descriptive data to one or more user devices.

To generate the flight path, the computer-executable instructions may further cause the system to: receive an indication of a departure airport and a destination airport; identify a starting time for the flight path based on the flight data and the departure airport; identify an ending time for the flight path based on the flight data and the destination airport; identify one or more intermediate airports based on the starting time for the flight path, the ending time for the flight path, and the flight data; generate the flight path based on the departure airport, the destination airport, the starting time, the ending time, and the one or more intermediate airports.

The computer-executable instructions may further cause the system to: identify at least one instance of content based on the indicated airplane, the flight path, the one or more airports, or the user associated with the indicated airplane; and cause the display to display the at least one instance of content.

To receive the indication of flight data, the computer-executable instructions may further cause the system to: detect that the indicated airplane has taken off from or landed at an airport; and in response to detecting that the indicated airplane has taken off from or landed at an airport, transmit a request for flight data to a flight repository.

The flight data may include flight data for two or more flights. To generate the flight path, the computer-executable instructions may further cause the system to: receive an indication of two or more stops via user input; receive an indication of an order of the two or more stops via user input; and generate a flight track based on the indication of flight data, the indication of two or more stops, and the indication of the order of the two or more stops.

The flight data may include data indicating one or more of: latitude, longitude, altitude, groundspeed for at least one latitude; for at least one longitude; and for at least one altitude.

The computer-executable instructions may further cause the system to: identify a user of the second user device; identify an airport ribbon display setting associated with the user of the second user device; identify one or more airports indicated by the flight path; and cause an airport ribbon to be displayed on the second user device based on the identified one or more airports and the airport ribbon display setting.

The computer-executable instructions may further cause the system to: permit the second user device to display a post based on the flight path and descriptive data, in which the post includes a user interface component indicating that the user of the second user device has interacted with the post; determining whether the user of the second user device has interacted with the post; and based on a determination that the user of the second user device has interacted with the post, causing the user interface component indicating that the user of the second user device has interacted with the post to move.

The computer-executable instructions may further cause the system to: permit the second user device to display a post based on the flight path and descriptive data, where the post includes a representation of the flight path, and where the representation of the flight path includes an indication of one or more of: a starting point of the flight path; an ending point of the flight path; a groundspeed of an airplane that flew along the flight path; a crosswind experienced by an airplane that flew along the flight path; a turbulence experienced by an airplane that flew along the flight path; a g-force experienced by an airplane that flew along the flight path; a time of day during which an airplane flew along the flight path; a stop made by an airplane that flew along the flight path; or a radio call made by an occupant of an airplane that flew along the flight path.

The representation of the flight path may include two or more colors. The computer-executable instructions may further cause the system to: receive an indication that a user is color-blind; and select the two or more colors to be easily distinguished from each other based on the indication that the user of the is color-blind.

The computer-executable instructions may further cause the system to: receive flight data associated with the flight path; receive additional data from one or more sensors for measuring movement that were present on the airplane while the airplane was flying along the flight path; generate a score indicating the proficiency of a pilot of the airplane based on the flight data and the additional data.

The flight data may include data generated by one or more of: data obtained from ADS-B, GPS, Garmin watch, a global-positioning-system device, an automatic dependent surveillance broadcasting device, a wearable user device, and a black box of an airplane.

The computer-executable instructions may further cause the system to: receive input indicating an off-airport landing area; receive an indication of off-airport landing data; update a repository of off-airport landing area information based on the indication of off-airport landing data and the indicated off-airport landing area; and display one or more off-airport landing areas to one or more users.

The computer-executable instructions may further cause the system to: receive health data from one or more sensors configured to obtain health data for the user; determine one or more stress levels of the user based on the received health data; and indicate at least one of the determined stress levels to the user from which the data was obtained.

To generate the flight path, the computer-executable instructions may further cause the system to: detect that the flight data does not include data for one or more locations at which the airplane flew during a flight; extrapolate flight data for the airplane based on at least a portion of the flight data; and combine the flight data and the extrapolated flight data, such that the final flight data includes flight data for the one or more locations.

To receive the indication of flight data, the computer-executable instructions may further cause the system to: receive additional data from one or more sensors for measuring movement that were present on the airplane while the airplane was flying along the flight path; and generate, based on the flight data and the additional data, one or more measures of at least one of: turbulence experienced by occupants of the airplane or a g-force experienced by occupants of the airplane. Implementations of the described techniques may include hardware, a method or process, or computer software on a computer-accessible medium.

One general aspect includes a non-transitory computer-readable medium having contents configured to cause at least one processor to perform a method comprising: receiving an indication of an airplane associated with a user; receiving an indication of flight data from one or more flight data repositories based on the indication of the indicated airplane; identifying one or more airports based on the flight data; generating a flight path based on the identified one or more airports, the flight data, and the indicated airplane; receiving an indication of descriptive data regarding the flight path; causing a display to visually display a pattern showing an indication of the flight path and an indication of the descriptive data to the user on a first user device; and causing the flight path and the descriptive data to be transmitted to a second user device.

Other embodiments of this aspect include corresponding computer systems, apparatus, and computer programs recorded on one or more computer storage devices, each configured to perform the various operation, actions and methods described and claimed herein.

### BRIEF DESCRIPTION OF THE SEVERAL VIEWS OF THE DRAWINGS

FIG. 1 is a display diagram of a sample main page for an application that accesses an information exchange platform for airplane pilots, according to various embodiments described herein.

FIG. 2 is a sample flow diagram of a process for transmitting an information exchange post regarding a flight path, according to various embodiments described herein.

FIG. 3 is a display diagram of a sample post creation page, according to various embodiments described herein.

FIG. 4 is a display diagram of a user interface for selecting an airplane and flight data, according to various embodiments described herein.

FIG. 5 is a display diagram of a user interface that indicates a sample post feed, according to various embodiments described herein.

FIG. 6 is a sample flow diagram of a process for automatic flight path stitching, according to various embodiments described herein.

FIG. 7 is a flow diagram for a sample process for manual flight path stitching, according to various embodiments described herein.

FIG. 8A is a display diagram of a user interface for manual flight track stitching, according to various embodiments described herein.

FIG. 8B is a display diagram of a second user interface for manual flight track stitching, according to various embodiments described herein.

FIG. 9 is a sample flow diagram of a process for generating an airport ribbon, according to various embodiments described herein.

FIG. 10 is a sample flow diagram of a process for displaying content to a user based on airplane attributes, according to various embodiments described herein.

FIG. 11 is a flow diagram of a sample process for displaying content to a user based on a home airport of a user, according to various embodiments herein.

FIG. 12 is a flow diagram of a sample process for displaying content to a user based on an upcoming inspection of an airplane associated with a user, according to various embodiments described herein.

FIG. 13 is a sample flow diagram of a process for displaying content to a user based on user attributes, according to various embodiments described herein.

FIG. 14 is a flow diagram of a sample process for identifying off-airport landing areas, according to various embodiments described herein.

FIG. 15 is a display diagram of a user interface for selecting an off-airport landing area, according to various embodiments described herein.

FIG. 16A is a display diagram of a user interface for inputting off-airport landing areas according to various embodiments described herein.

FIG. 16B is a display diagram of a second user interface for selecting an off-airport landing area, according to various embodiments described herein.

FIG. 17 is a process for stress tracking during a flight track, according to various embodiments described herein.

FIG. 18 is a user interface for displaying stress tracking on a flight map, according to various embodiments described herein.

FIG. 19 is a display diagram of a stress tracking statistics page displayed to a user, according to various embodiments described herein.

FIG. 20 is a flow diagram of a sample process for updating flight hours, according to various embodiments described herein.

FIG. 21 is a display diagram of a user interface indicating a user profile, according to various embodiments described herein.

FIG. 22 is a display diagram of an airport data page, according to various embodiments described herein.

FIG. 23 is a display diagram of an airport weather page, according to various embodiments described herein.

FIG. 24 is a sample flow diagram of a process for identifying turbulence experienced during a flight path, according to various embodiments described herein.

FIG. 25 is a sample flow diagram of a process for identifying the G-Force experienced by occupants of an airplane during a flight path, according to various embodiments described herein.

FIG. 26 is a sample flow diagram of a process for identifying a stick and rudder rating for a pilot, according to various embodiments described herein.

FIG. 27 is a block diagram of an example user device, according to various embodiments described herein.

FIG. 28 is a display diagram of a sample server associated with the information exchange platform, according to various embodiments described herein.

### DETAILED DESCRIPTION

Airplane pilots typically have few, if any, places to share information regarding airports, their airplanes, flight paths, their flying skills, and other information unless they do so over the radio during their flights or by directly interacting with each other when meeting, for example, at an airport lounge or other location. Furthermore, airplane pilots do not have any mechanisms to automatically retrieve their flight data, nor do they have any mechanisms to analyze their flight data to prepare it to share with other pilots that will be meaningful to them as a pilot.

The embodiments disclosed herein provide an information exchange platform for airplane pilots to enable them to share information and data regarding their flights, airports of interest to the pilots, their flying skill, analysis of their flight paths, and other information or data of interest to pilots or their planes. In some embodiments, aspects of the information exchange platform automatically obtain and combine flight paths for an airplane pilot and enable the pilot to share their flight path with other pilots. In some embodiments, aspects of the information exchange platform service identify content to present to the pilot based on one or more attributes of the pilot or one or more planes associated with the pilot.

The information exchange platform can take various forms and be described various ways. It can be considered a type of public posting board, an application with shared data, a social media service, or other exchange of information and data between a pilot and the general public or within a select group of pilots who have joined the same data sharing platform. For ease of reference, it will be referred to hereinafter as a social media service in the broadest meaning of the term and thus includes within this broad meaning any information exchange platform that may include just software or combinations of hardware, software, smart phones, smart computing devices, AI and other information storage and exchange platforms. It therefore not limited to nor defined as being solely a social media service. In some embodiments, aspects of the social media service include a social media application that provides tools, displays, and information specific to pilots. Such an application provides benefits not available on general social media applications. Furthermore, aspects of such an application may be operated, executed, or otherwise used by computing devices associated with the social media service, such as one or more server devices that host data related to a social media service, one or more user devices used by users for accessing the social media service, or other computing devices associated with the social media service.

In some embodiments, a user may access one or more aspects of the social media service for airplane pilots, receive data regarding one or more social media posts submitted by users of the social media service for airplane pilots, or receive other data received by, generated by, or otherwise associated with, the social media service for airplane pilots via a user device, such as a smartphone; tablet computing device; wearable computing device such as a smartwatch, VR headset, etc.; laptop; desktop computer; or other computing devices. In some embodiments, the user accesses aspects of the social media service for airplane pilots via a software application. For example, the user may access the social media service via smartphone application downloaded from an application “play store” or other repository for smartphone applications. In some embodiments, the user may access the social media service via a webpage.

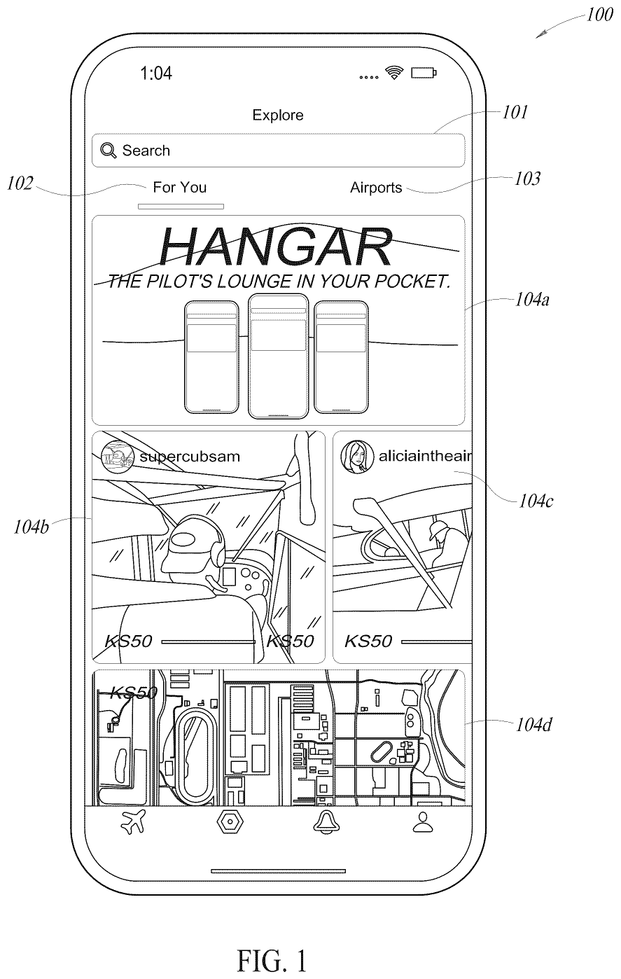

FIG. 1 is a display diagram of a sample main page 100 for an application that accesses the social media service for airplane pilots, according to various embodiments described herein. The main page 100 may include a search bar 101 that enables a user to search for one or more users, one or more airports, one or more locations, or some combination thereof. When the “For You” tab 102 is selected, the main page 100 may include one or more instances of content relevant to a user, such as one or more advertisements, one or more posts by other users, information regarding one or more airports of interest to the user, other content that may be of interest to the user, or some combination thereof, such as the content and posts 104a-104d (collectively “content and posts 104”). When the “Airports” tab 103 is selected, the main page may display one or more instances of content associated with one or more airports of interest to the user. In some embodiments, a user may select or otherwise identify one or more airports of interest, which may be referred to as a “home airport” of the user.

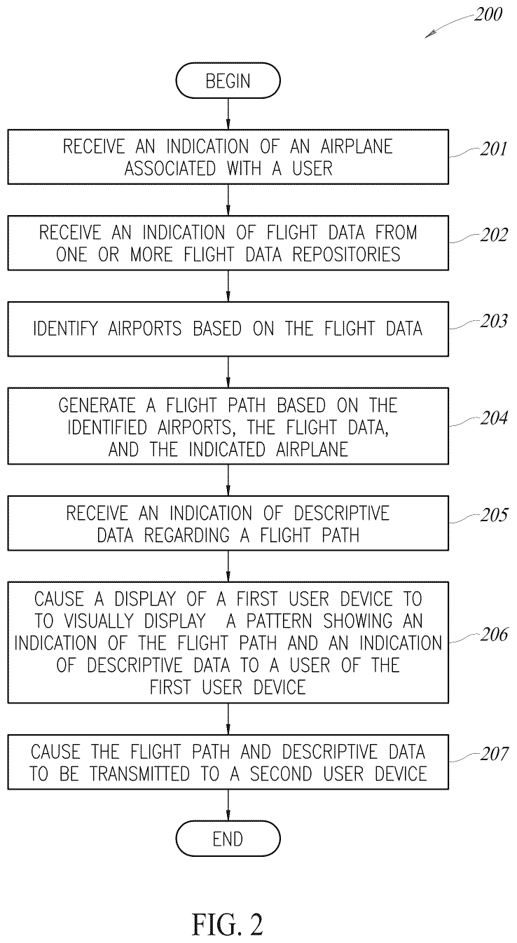

FIG. 2 is a sample flow diagram of a process 200 for transmitting a social media post regarding a flight path, according to various embodiments described herein. Aspects of the social media service for airplane pilots, such as an application associated with the social media service for airplane pilots (“the social media service”), may perform a process for transmitting a social media post regarding a flight path to one or more user devices, according to various embodiments described herein. Any aspect of the social media service for airplane pilots, such as a server, smartphone, application, wearable device, or other device associated with an aspect of the social media service, may perform any one or more of the acts described with respect to the process for transmitting a social media post regarding a flight path.

The process for transmitting a social media post 200 may begin, after a start block, at act 201, where the application receives an indication of an airplane associated with a particular user. In some embodiments, the indication of the airplane associated with the specific user may be received via user input. For example, the user may provide input indicating an airplane, type of airplane, tail number of an airplane, or other data indicating an airplane, to a user interface configured to receive such data, such as an interface provided via a smartphone application, webpage, etc. In some embodiments, one or more default indications of airplanes may be provided to the user for selection, such as an indication of one or more airplanes that the user has indicated that they have flown in the past, one or more airplanes the user has indicated that they own, one or more airplanes that the user has rented, one or more airplanes included in data indicating a profile of the user, or one or more airplanes otherwise associated with, relevant to, etc., the user.

The process 200 may proceed to act 202, where the application receives an indication of flight data from one or more flight data repositories based on the indication of the airplane. In some embodiments, the flight data repositories include one or more of: a flight data repository associated with a government entity, such as the Federal Aviation Administration (“FAA”), a flight data repository associated with an entity other than the user or social media service, a flight data repository associated with the social media service, or other flight data repositories. In some embodiments, the flight data is formatted in a JavaScript Object Notation (“JSON”) format. In some embodiments, the flight data includes Automatic Dependent Surveillance-Broadcast data. In some embodiments, at least a portion of the flight data is received from a black box of an airplane, such as the indicated airplane. In some embodiments, at least a portion of the flight data is received from one or more computing devices, such as a smartphone, smartwatch, smart-glasses, tablet, other wearable computing devices, a global-positioning-system device (“GPS”), weather data tracking systems, radio devices, or any other computing device. In some embodiments, the flight data may include: health data associated with the user, such as a heart rate, blood-oxygen level, an indication of stress experienced by the user, or other health data; accelerometer data; gyroscope data; weather data; data indicating radio transmissions transmitted by a radio of the airplane; radar data; data input by the user via the user interface; an indication of one or more locations at which the indicated airplane was located in the past; one or more times at which the airplane took off from or landed at an airport; one or more airports at which the airplane was located; one or more groundspeeds of the airplane during various times of the flight; one or more altitudes of an airplane; or some combination thereof.

In some embodiments, the flight data is flight data for the indicated airplane that was generated within a threshold time period. In some embodiments, the threshold time period may be a time period selected by the user. In some embodiments, the threshold time period may be a time period selected by an aspect of the social media service, such as a time period selected based on one or more takeoff or landing times of the airplane, a time period selected based on one or more airports at which the airplane was located, other considerations for selecting a time period for generating a flight path, or some combination thereof. For example, one or more aspects of the social media service may determine whether the airplane took off from or landed at a “home” airport of the user, and may select the threshold period of time based on the airplanes takeoff from, landing at, or some combination thereof, the home airport.

In some embodiments, the flight data is automatically retrieved from one or more flight data repositories. In such embodiments, the flight data may be automatically retrieved by periodically requesting flight data for one or more airplanes associated with a user. Thus, in such embodiments, the flight data does not have to be requested by the user in order for aspects of the social media service to receive the flight data. In some embodiments, aspects of the social media service, such as the application, may prompt the user to create a post in response to the automatic retrieval of flight data for an airplane associated with the user.

The process 200 may proceed to act 203, where the application identifies one or more airports based on the flight data.

The process 200 may proceed to act 204, where the application generates a flight path based on the identified airports, the flight data, and the indicated airplane. In some embodiments, the flight data does not include flight data for one or more geographic locations at which the airplane was located while flying along the flight path. For example, in some cases, ADS-B data is unable to be obtained because the airplane is not within the line of sight of an ADS-B radar. In such cases, aspects of the social media service may adjust the flight data to remedy the absence of the ADS-B data, such as by extrapolating one or more locations of an airplane based on a speed, latitude, longitude, altitude, or some combination thereof, of one or more points that are present in the ADS-B data. In another example, aspects of the social media service may adjust the flight data by adding a speed, latitude, longitude, altitude, or some combination thereof for one or more points in a straight line path between two points between which the ADS-B data is absent.

The process 200 may proceed to act 205 where the application receives an indication of a descriptive data regarding the flight path. In some embodiments, at least a portion of the descriptive data is received via user input. In some embodiments, at least a portion of the descriptive data is generated by one or more aspects of the social media service based on the flight data. In some embodiments, the descriptive data includes an image, a comment, a review, other descriptive data for a flight path, or some combination thereof.

In some embodiments, the process for transmitting a social media post 200 may proceed to generate a social media post based on the flight path and the descriptive data.

The process 200 may proceed to act 206, where the application causes a display of a first user device to visually display a pattern showing an indication of the flight path and an indication of the descriptive data to the user of a first user device. In some embodiments, the display of the user device displays the generated post. In some embodiments, the first user device performs at least some of the acts described in connection with the process 200.

The process 200 may proceed to act 207, where the application causes the flight path and the descriptive data to be transmitted to a second user device. In some embodiments, causing the flight path to be transmitted to a second user device includes transmitting data indicating the generated post to a server device associated with the social media service. In such embodiments, the second user device may request one or more posts from the social media service and receive the generated post in response to the request.

After the flight path and descriptive data are caused to be transmitted to the second user device, the process for transmitting a social media post 200 ends.

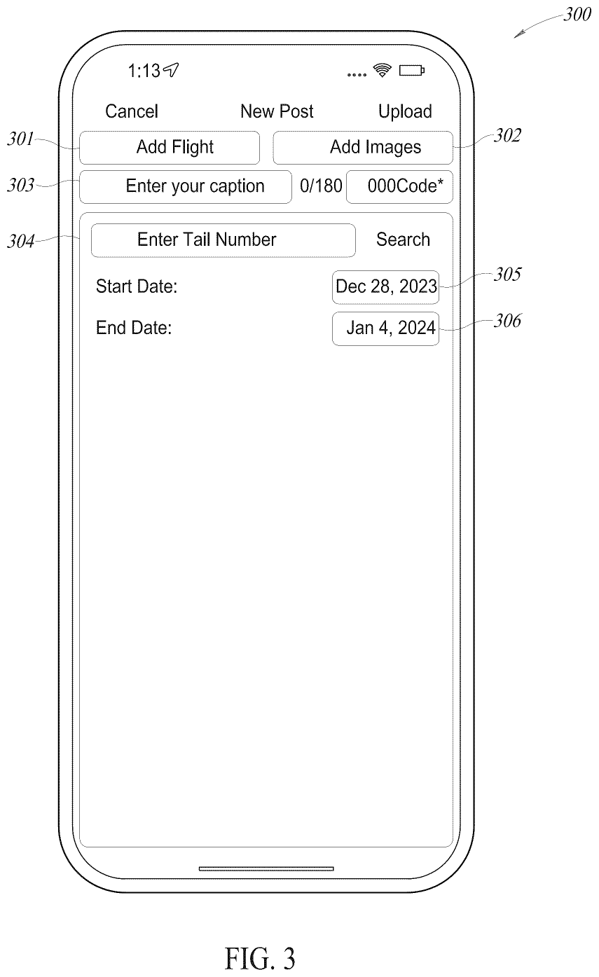

FIG. 3 is a display diagram of a sample post creation page 300, according to various embodiments described herein. The post creation page 300 includes an add flight icon 301, an add images icon 302, a caption text box 303, a tail number search bar 304, a start date user interface component 305, and an end date user interface component 306. In some embodiments, aspects of the social media service use the post creation page 300 to receive input from a user that may be used to perform at least a portion of the process for transmitting a social media post 200, such as the indication of an airplane, a threshold time period, and descriptive data.

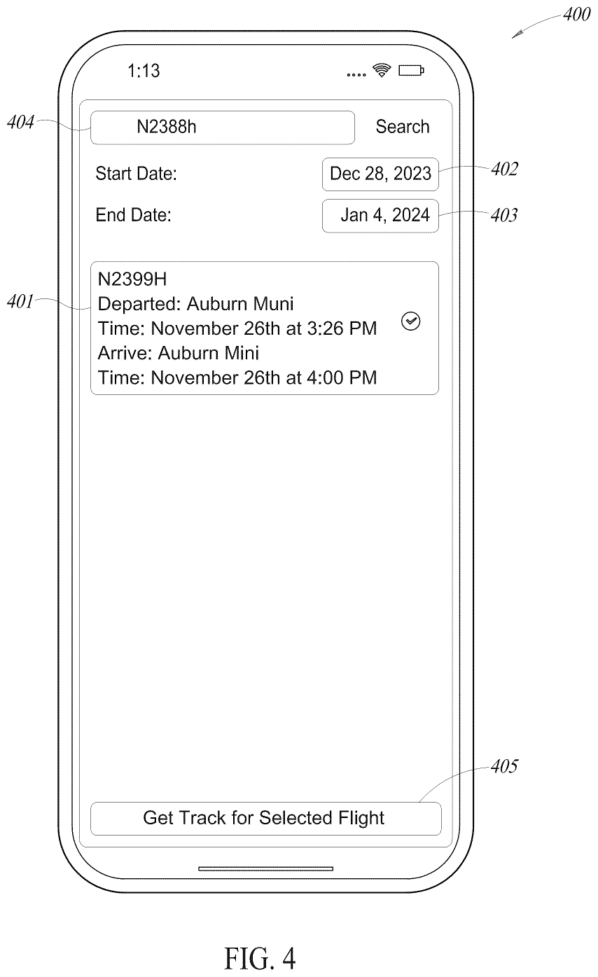

Interacting with the tail number search bar 304 enables a user to search for an airplane based on tail number of the airplane. In some embodiments, the user is enabled to search for an airplane based on criteria other than the tail number. Interacting with the start date and end date user interface components 304 and 305 enable a user to select a threshold period of time within which flight data is searched. Interacting with the add image field 302 enables a user to select an image or other media content to include in a post generated by aspects of the social media service. Interacting with the caption text box 303 enables a user to include text that is included in a caption for a post generated by aspects of the social media service. Interacting with the add flight field 301 enables a user to add a flight of an airplane indicated by tail number entered in the tail number search bar and that occurred between the start and end dates selected via the start date and end date user interface components 304 and 305. In some embodiments, interacting with the add flight field 301 causes an application to display the user interface for selecting an airplane and flight data 400, described below in connection with FIG. 4. In some embodiments, interacting with the add flight field 301 causes an application to transmit data to a flight data repository that includes the indicated airplane and start and end dates. The application may receive, in response, flight data based on the indicated airplane and start and end dates.

In some embodiments, the application searches for flight data generated within a threshold period of time for an indicated airplane. In such embodiments, it is possible that the post creation page 300 does not include the start and end date user interface components 304 and 305. For example, the application may search for flight data for flights occurring within the last fourteen days, or within another selected period of time, based on the indicated airplane.

In some embodiments, the application receives an indication that an airplane associated with a user has taken off or landed. In some embodiments, the application may present a notification to the user that the airplane has taken off or landed. In some such embodiments, the application may automatically obtain flight data for the airplane based on the indication that the airplane associated with the user has taken off or landed. In some embodiments, the application may present the automatically obtained flight data to the user within the post creation page.

FIG. 4 is a display diagram of a user interface for selecting an airplane and flight data 400, according to various embodiments described herein. The user interface for selecting an airplane and flight data 400 includes one or more flight data user interface components 401, a start date user interface component 402, an end date user interface component 403, a tail number search bar 404, and a get track field 405. The start date user interface component 402, end date user interface component 403, and tail number search bar 404 may be similar to the start date user interface component 305, end date user interface component 306, and tail number search bar 304 described above with respect to FIG. 3. Interacting with the one or more flight data user interface components 401 enables a user to select flight data for one or more flights indicated by flight data retrieved from a repository of flight data based on the period of time indicated by the start and end date user interface components 402 and 403 and the tail number search bar 404. Interacting with the get track field 405 enables a user to confirm the selection of flight data. In some embodiments, the user interface for selecting an airplane and flight data 400 enables a user to select flight data for multiple flights. In such embodiments, selecting multiple flights may cause the application to combine multiple flights into one flight path, such as by using the process for automatic flight path stitching 600, the process for manual flight path stitching 700, or some combination thereof.

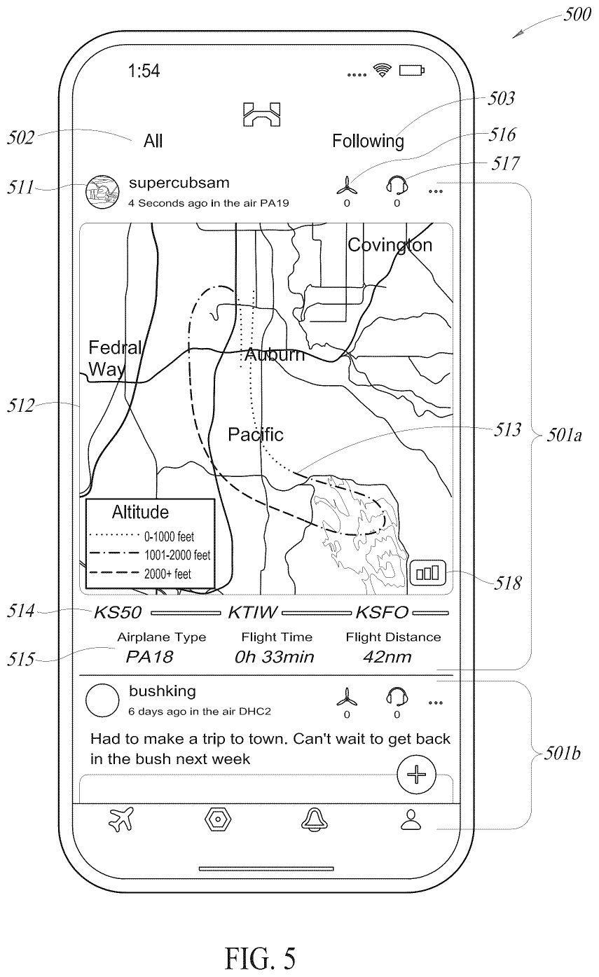

FIG. 5 is a display diagram of a user interface that indicates a sample post feed 500, according to various embodiments described herein. The user interface that indicates a sample post feed 500 includes one or more posts generated based on flight data 501a-501n (collectively “posts 501” or individually as “post 501”), an all page icon 502, and a following page icon 503. Interacting with the all page icon enables a user to view posts from users and airports that the user “follows” and posts from users and airports that the user does not follow. Interacting with the following page icon enables a user to view posts from users and airports that the user follows. In some embodiments, a user may indicate to the social media service that they wish to follow a second user or an airport, such as via a user interface component included on a page that displays the second user or the airport, a user interface component that receives a username or other identifier for the second user or the airport, or other methods of determining whether a user wishes to follow a second user or airport.

A post, such as the post 501a, may include an indication of the user that created the post 511, a flight map 512, one or more flight tracks 513, an airport ribbon 514, descriptive information regarding the flight track 515, a prop icon 516, a comments icon 517, and an additional detail icon 518. The flight map 512 is a map that depicts at least a portion of the geographic area in which the airplane indicated by the post flew. The flight track 513 indicates a path along which the airplane flew. In some embodiments, the flight track 513 is displayed with a gradient that indicates: a starting point and ending point of a flight, one or more altitudes of the airplane, one or more groundspeeds of an airplane, one or more measures of the turbulence experienced by the airplane as it traveled along the flight track, one or more measures of the G-Force experienced by occupants of the airplane as the airplane traveled along the flight track, other data related to the flight of the airplane, or some combination thereof. In some embodiments, the flight map 512 includes an indication of one or more radio calls made by a pilot of the airplane (not shown). In some embodiments, the flight map may include one or more user interface components that enable a user to listen to the one or more radio calls (not shown). In some embodiments, the user interface components indicating the radio calls are placed on the flight track at locations that represent a location at which the radio call occurred. In some embodiments, the flight map 512 includes one or more user interface components that indicate a crosswind experienced by the airplane at one or more locations along the flight path.

In some embodiments, interacting with the comments icon 517 enables a user to view comments on the post made by other users of the social media service. In some embodiments, interacting with the prop icon 516 changes a color of the prop icon 516. In some embodiments, interacting with the prop icon 516 causes the prop icon 516 to move, such as by spinning the prop icon 516.

The airport ribbon 514 indicates one or more airports at which the airplane landed at, took off from, or some combination thereof, during the flight path. In some embodiments, interacting with the airport ribbon 514 allows the user to scroll through the airport ribbon 514 and view each of the airports at which the airplane landed, took off, or some combination thereof. In some embodiments, the color scheme of the flight track 513 is changed based on the airport at which the airplane took off or landed, such as by changing the gradient, changing the flight track to a different color, other changes to the color scheme of the flight track 513, or some combination thereof. As indicated in FIG. 5, by the changes from dots to dots-and-dashes to dashes, the color can change along the flight path. In FIG. 5, the dot and dash combination of flight path 513 indicate different colors that are displayed at different locations along the flight path and represent the altitude of the plane at those locations.

If different colors are used to mean different things along a flight path, colors can be selected that a colorblind user is able to easily distinguish from each other, such as a gradient from red to yellow. In such embodiments, an application or other aspect of the social media service may include a place for the user to input an indication that they are color blind. If the application has information regarding a type of colorblindness experienced by the user, then it may change the color of the gradient path based on such an indication to provide a color change that is easily distinguished by that particular user. For example, red and green appear identical or very similar to each other for some types of color blindness while yellows, blues, orange, purple, and other colors can be easily distinguished from both red and green and from each other. For other types of color blindness, various colors appear the same, while other colors and/or gray scale can be easily distinguished from each other. The user, if color blind, can provide an indication of the type of color blindness or a listing of preferred display colors and/or a gray scale and can thus have a display custom for them that provides ease understanding the data being viewed.

In some embodiments, the flight map 512 indicates a time at which the flight track 513 occurred. For example, the color scheme of the flight map may be changed to indicate whether the airplane was flying at night, during the day, or some combination thereof.

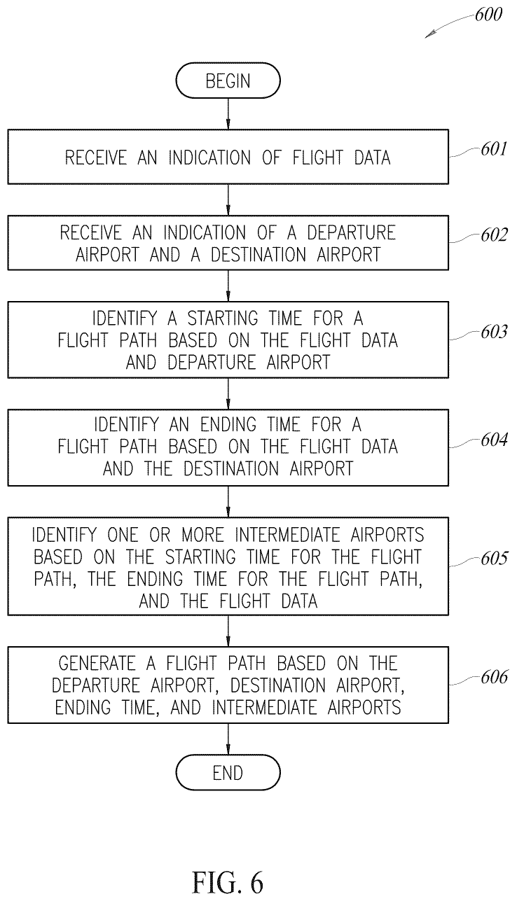

FIG. 6 is a sample flow diagram of a process for automatic flight path stitching 600, according to various embodiments described herein. Aspects of the social media service for airplane pilots, such as an application associated with the social media service, may perform a process for automatic flight path stitching, according to various embodiments described herein. Any aspect of the social media service for airplane pilots, such as a server, smartphone, application, wearable device, or other device associated with an aspect of the social media service, may perform any one or more of the acts described with respect to the process for automatic flight path stitching.

The process for automatic flight path stitching 600 may begin, after a start block, at act 601, where the application receives an indication of flight data. In some embodiments, the flight data is flight data collected, generated, received, created, etc., within a threshold period of time.

The process for automatic flight path stitching 600 may proceed to act 602, where the application receives an indication of a departure airport and a destination airport. In some embodiments, an aspect of the social media service automatically identifies the departure airport, destination airport, or some combination thereof, based on an amount of time during which the airplane was located at an airport, a determination of whether the airplane returned to an airport, a determination of whether one of the airports is an airport associated with the user, such as a home airport, via user input, or some combination thereof.

The process for automatic flight path stitching 600 may proceed to act 603, where the application identifies a starting time for the flight path based on the flight data and the departure airport.

The process for automatic flight path stitching 600 may proceed to act 604, where the application identifies an ending time for the flight path based on the flight data and the destination airport.

The process for automatic flight path stitching 600 may proceed to act 605, where the application identifies one or more intermediate airports based on the starting time for the flight path, the ending time for the flight path, and the flight data.

The process for automatic flight path stitching 600 may proceed to act 606, where the application generates a flight path based on the departure airport, destination airport, starting time, ending time, and the one or more intermediate airports.

After the flight path is generated, the process for automatic flight path stitching 600 ends.

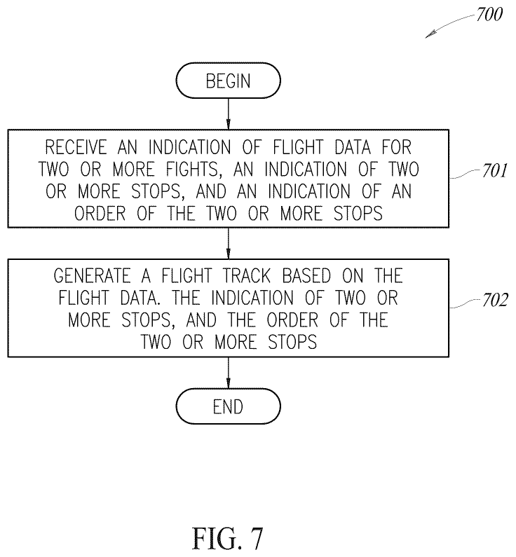

FIG. 7 is a flow diagram for a sample process for manual flight path stitching 700, according to various embodiments described herein. Aspects of the social media service for airplane pilots, such as an application associated with the social media service, may perform a process for manual flight path stitching 700, according to various embodiments described herein. Any aspect of the social media service for airplane pilots, such as a server, smartphone, application, wearable device, or other device associated with an aspect of the social media service, may perform any one or more of the acts described with respect to the process for manual flight path stitching 700.

The process for manual flight path stitching 700 begins, after a start block, at act 701, where the application receives an indication of flight data for two or more flights, an indication of two or more stops via user input, and an indication of an order of the two or more stops.

The process for manual flight path stitching 700 proceeds to act 702, where the application generates a flight track based on the flight data for two or more flights, the two or more stops, and the order of the two or more stops.

After act 702, the process for manual flight path stitching 700 ends.

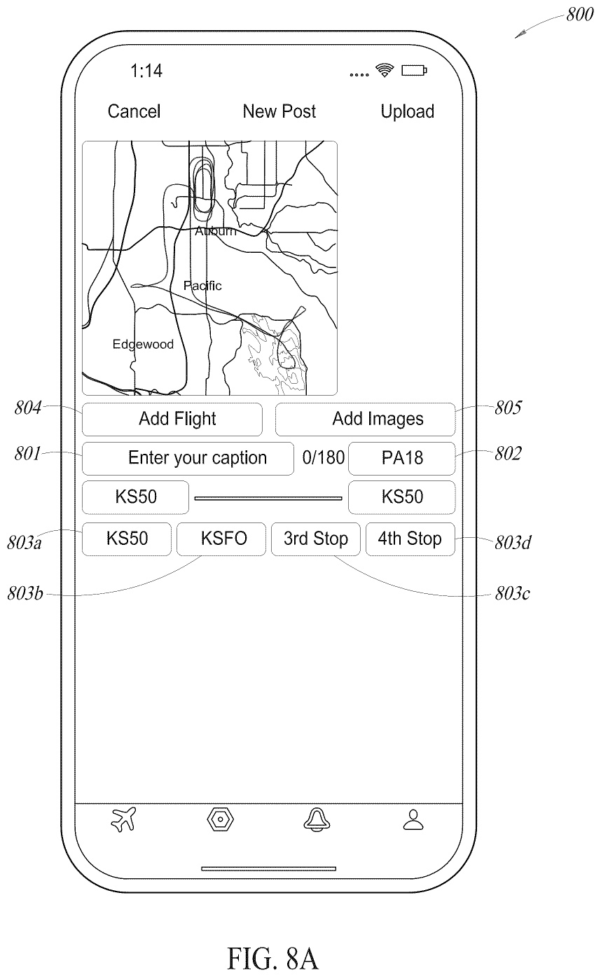

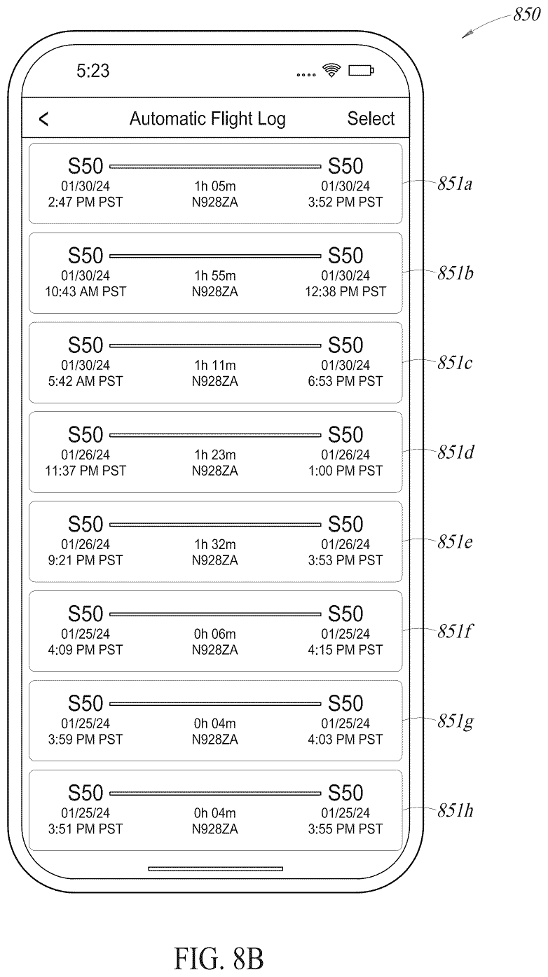

FIG. 8A is a display diagram of a user interface for manual flight track stitching 800, according to various embodiments described herein. In some embodiments, an aspect of the social media service uses the user interface for manual flight track stitching 800 as part of performing the process for manual flight track stitching 700, described above in connection with FIG. 7. The user interface for manual flight track stitching 800 includes a caption textbox 801, a tail number indicator 802, one or more user interface components for adding airport stops 803a-803d (collectively “user interface components for adding airport stops 803”), and add flight icon 804, and an add image field 805. The caption textbox 801, add flight field 804, and add image field 805 may be similar to the caption text box 303, add flight field 301, and add image field 303 described above in connection with FIG. 3. The tail number indicator 802 may indicate the tail number of one or more airplanes for which the flight track is generated. Interacting with the user interface components for adding airport stops 803 enables a user to select two or more airports for the flight track and the order for which the airports were visited.

FIG. 8B is a display diagram of a second user interface for manual flight track stitching 850, according to various embodiments described herein. The second user interface for manual flight track stitching 800 includes one or more user interface components indicating a flight track 851a-851h (collectively “user interface components for indicating a flight track 851”) generated for one or more flights. Interacting with the user interface components for indicating a flight track 851 may enable a user to select one or more flight tracks to be stitched together, such as by using the process for manual flight path stitching 700 described above. In some embodiments, the selected flight tracks are presented to the user in a user interface, such as the user interface 800 described above in connection with FIG. 8A.

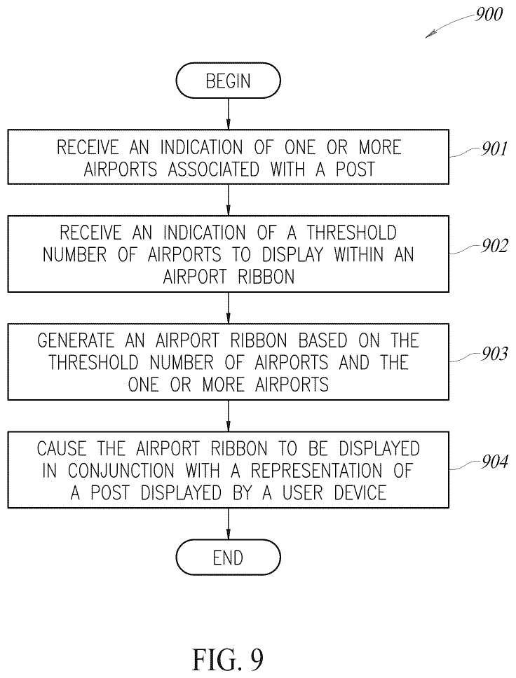

FIG. 9 is a sample flow diagram of a process for generating an airport ribbon 900, according to various embodiments described herein. Aspects of the social media service for airplane pilots, such as an application associated with the social media service, may perform a process for generating an airport ribbon 900, according to various embodiments described herein. Any aspect of the social media service for airplane pilots, such as a server, smartphone, application, wearable device, or other device associated with an aspect of the social media service, may perform any one or more of the acts described with respect to the process for generating an airport ribbon 900.

The process for generating an airport ribbon 900 begins, after a start block, at act 901, where the application receives an indication of one or more airports associated with a post. In some embodiments, the indication of one or more airports associated with a post is included in data associated with a post that is transmitted to a user device from the social media service.

The process for generating an airport ribbon 900 may proceed to act 902, where the application receives an indication of a threshold number of airports to display within an airport ribbon. In some embodiments, indication of the threshold number of airports to display may be received via user input. In some embodiments, one or more aspects of the social media service determine the threshold number of airports based on the number of airports that can be displayed by the display that presents the post to a user. For example, the threshold number of airports may be determined based on attributes of the display such as screen size, the amount of display space occupied by posts, other factors that affect the number of user interface elements that can be displayed, or some combination thereof.

The process for generating an airport ribbon 900 may proceed to act 903, where the application generates an airport ribbon based on the threshold number of airports and the indicated one or more airports. In some embodiments, the airport ribbon is generated such that the airports are displayed in the order of a flight path indicated by the post.

The process for generating an airport ribbon 900 may proceed to act 904, where the application causes the airport ribbon to be displayed in conjunction with a representation of the post displayed by a user device.

After causing the airport ribbon to be displayed, the process for generating an airport ribbon 900 ends.

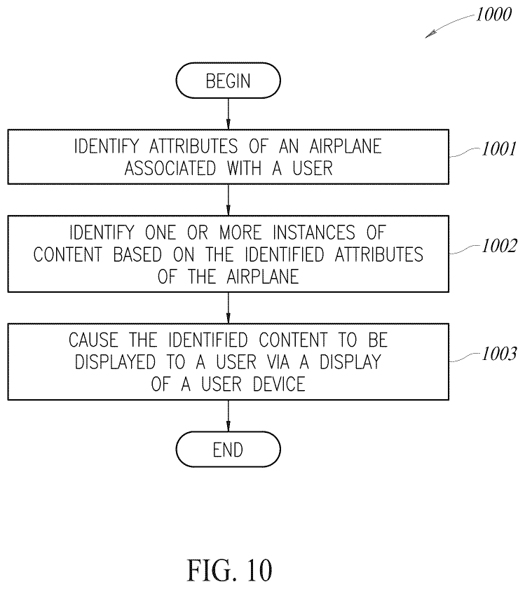

FIG. 10 is a sample flow diagram of a process for displaying content to a user based on airplane attributes 1000, according to various embodiments described herein. Aspects of the social media service for airplane pilots, such as an application associated with the social media service, may perform the process for displaying content to a user based on airplane attributes 1000, according to various embodiments described herein. Any aspect of the social media service for airplane pilots, such as a server, smartphone, application, wearable device, or other device associated with an aspect of the social media service, may perform any one or more of the acts described with respect to the process for displaying content to a user based on airplane attributes 1000. In some embodiments, at least a portion of the content displayed to the user is advertisement content.

The process for displaying content to a user based on airplane attributes 100 begins, after a start block, at act 1001, where the application identifies one or more attributes of one or more airplanes associated with a user. In some embodiments, the airplane attributes indicate whether the airplane is rented or owned by user, a cost of airplane, a make and model of airplane, one or more modifications to the airplane, one or more components or devices included in the airplane, other attributes of the airplane, or some combination thereof.

The process for displaying content to a user based on airplane attributes 1000, may proceed to act 1002, where the application identifies one or more instances of content based on the attributes of one or more airplanes. In some embodiments, the instances of content are received from one or more third party entities, such as entities other than the user or an entity associated with the social media service. In some embodiments a portion of the instances of content include advertisements.

The process for displaying content to a user based on airplane attributes 1000 may proceed to act 1003, where the application causes the identified instances of content to be displayed to the user via a display of a user device.

After the identified instances of content are caused to be displayed to the user, the process for displaying content to a user based on airplane attributes 1000 ends.

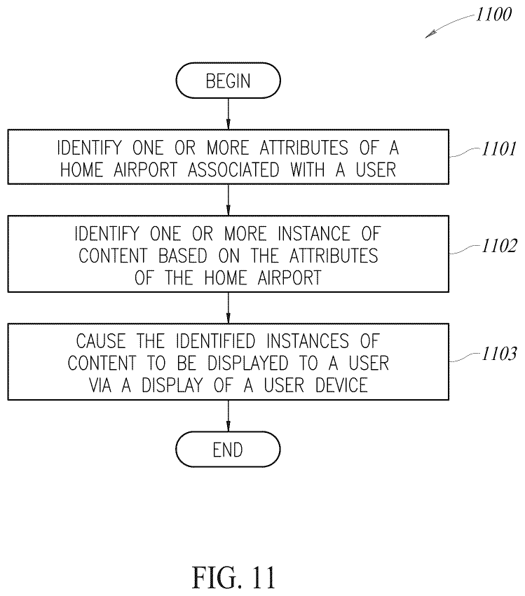

FIG. 11 is a flow diagram of a sample process for displaying content to a user based on a home airport of a user 1100, according to various embodiments herein. Aspects of the social media service for airplane pilots, such as an application associated with the social media service, may perform a process for displaying content to a user based on a home airport of a user 1100, according to various embodiments described herein. Any aspect of the social media service for airplane pilots, such as a server, smartphone, application, wearable device, or other device associated with an aspect of the social media service, may perform any one or more of the acts described with respect to the process for displaying content to a user based on a home airport of a user 1100. In some embodiments, at least a portion of the content displayed to the user is advertisement content.

The process for displaying content to a user based on a home airport of the user 1100 begins, after a start block, at act 1101, where the application identifies one or more attributes of a home airport associated with a user. In some embodiments, a user selects a home airport via user input. In some embodiments, the attributes of the home airport include a geographic area within which the home airport is located, a size of the home airport, an indication of one or more airports to which the user typically flies from the home airport, other attributes of the home airport, or some combination thereof.

The process for displaying content to a user based on a home airport of a user 1100 may proceed to act 1102, where the application identifies one or more instances of content based on the attributes of the home airport. In some embodiments, the instances of content are received from one or more third party entities, such as entities other than the user or an entity associated with the social media service. In some embodiments a portion of the instances of content include advertisements.

The process for displaying content to a user based on a home airport of a user 1100 may proceed to act 1103, where the application causes the identified instances of content to be displayed to the user via a display of a user device.

After the identified instances of content are caused to be displayed to the user, the process for displaying content to a user based on a home airport of a user 1100 ends.

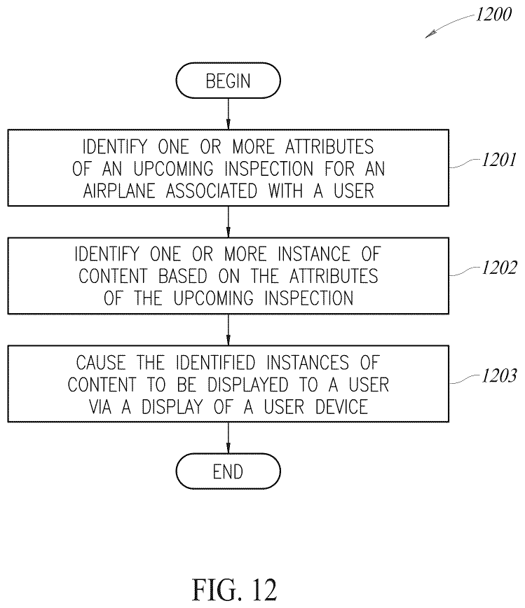

FIG. 12 is a flow diagram of a sample process for displaying content to a user based on an upcoming inspection of an airplane associated with a user 1200, according to various embodiments described herein. Aspects of the social media service for airplane pilots, such as an application associated with the social media service, may perform a process for displaying content to a user based on an upcoming inspection of an airplane associated with the user 1200, according to various embodiments described herein. Any aspect of the social media service for airplane pilots, such as a server, smartphone, application, wearable device, or other device associated with an aspect of the social media service, may perform any one or more of the acts described with respect to the process for displaying content to a user based on an upcoming inspection 1200. In some embodiments, at least a portion of the content displayed to the user is advertisement content.

The process for displaying content to a user based on an upcoming inspection 1200 begins, after a start block, at act 1201 where the application identifies one or more attributes of an upcoming inspection for an airplane associated with the user. In some embodiments, one or more times for the upcoming inspections are determined based on one or more attributes of an airplane associated with the user. In some embodiments, the attributes of the upcoming inspection include a type of the inspection, a time of the inspection, one or more tasks to be completed to pass the inspection, other attributes of an upcoming inspection, or some combination thereof.

The process for displaying content to a user based on an upcoming inspection 1200 may proceed to act 1202, where the application identifies one or more instances of content based on the attributes of the upcoming inspection. In some embodiments, the instances of content are received from one or more third party entities, such as entities other than the user or an entity associated with the social media service. In some embodiments a portion of the instances of content include advertisements.

The process for displaying content to a user based on an upcoming inspection 1200 may proceed to act 1203, where the application causes the identified instances of content to be displayed to the user via a display of a user device.

After the identified instances of content are caused to be displayed to the user, the process for displaying content to a user based on an upcoming inspection 1200 ends.

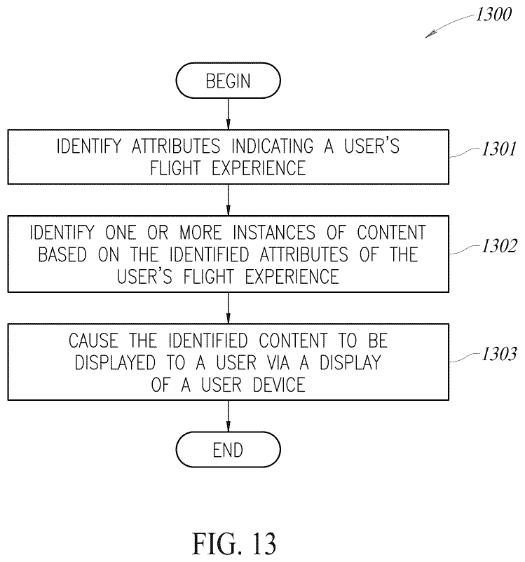

FIG. 13 is a sample flow diagram of a process for displaying content to a user based on user attributes 1300, according to various embodiments described herein. Aspects of the social media service for airplane pilots, such as an application associated with the social media service, may perform a process for displaying content to a user based on user attributes 1300, according to various embodiments described herein. Any aspect of the social media service for airplane pilots, such as a server, smartphone, application, wearable device, or other device associated with an aspect of the social media service, may perform any one or more of the acts described with respect to the process for displaying content to a user based on user attributes 1300. In some embodiments, the user attributes are an indication of one or more ratings associated with the user, a number of hours that the user has flown, other indications of the user's flight experience, or some combination thereof.

The process for displaying content to a user based on user attributes 1300 may begin, after a start block, at act 1301, where the application identifies one or more attributes of a user of the social media service for airplane pilots. In some embodiments, the user attributes include attributes that are indicative a user's flying experience, such as an indication of one or more types of aircraft the user has flown, an indication of the time the user has spent flying airplanes, an indication of one or more certifications that the user has received, or other data indicating a user's flying experience.

The process for displaying content to a user based on user attributes 1300 may proceed to act 1302, where the application identifies one or more instances of content based on the attributes of the user.

The process for displaying content to a user based on user attributes 1300 may proceed to act 1303, where the application causes the identified instances of content to be displayed to the user via a display of a user device.

After the identified instances of content are caused to be displayed to the user, the process for displaying content to a user based on user attributes 1300 ends.

In some embodiments, for any of the processes for displaying content described above with respect to FIGS. 10-13, the instances of content are displayed in conjunction with, interspersed with, etc., one or more posts, content displayed on a home page, such as the page described above in connection with FIG. 1, other aspects of the application or social media service, or some combination thereof. In some embodiments, the identified content is displayed in a popup window. In some embodiments, the identified content is transmitted to the user, such as via email, text message, other methods of presenting content, or a combination thereof.

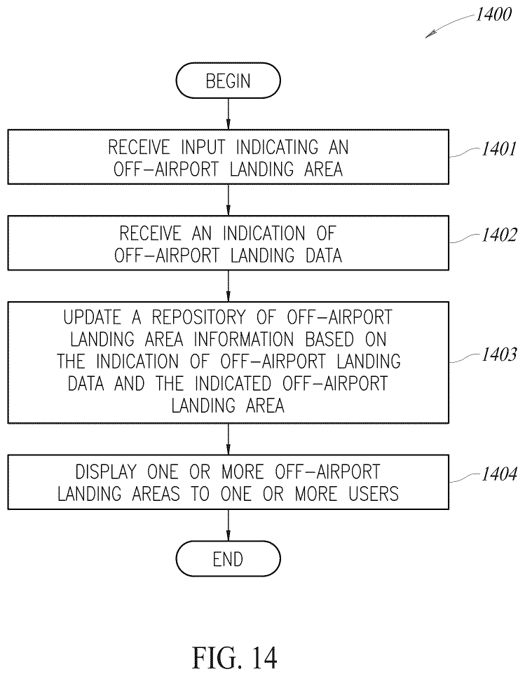

FIG. 14 is a flow diagram of a sample process for identifying off-airport landing areas 1400, according to various embodiments described herein. Aspects of the social media service for airplane pilots, such as an application associated with the social media service, may perform the process for identifying off-airport landing areas 1400. Any aspect of the social media service for airplane pilots, such as a server, smartphone, application, wearable device, or other device associated with an aspect of the social media service, may perform any one or more of the acts described with respect to the process for identifying off-airport landing areas 1400.

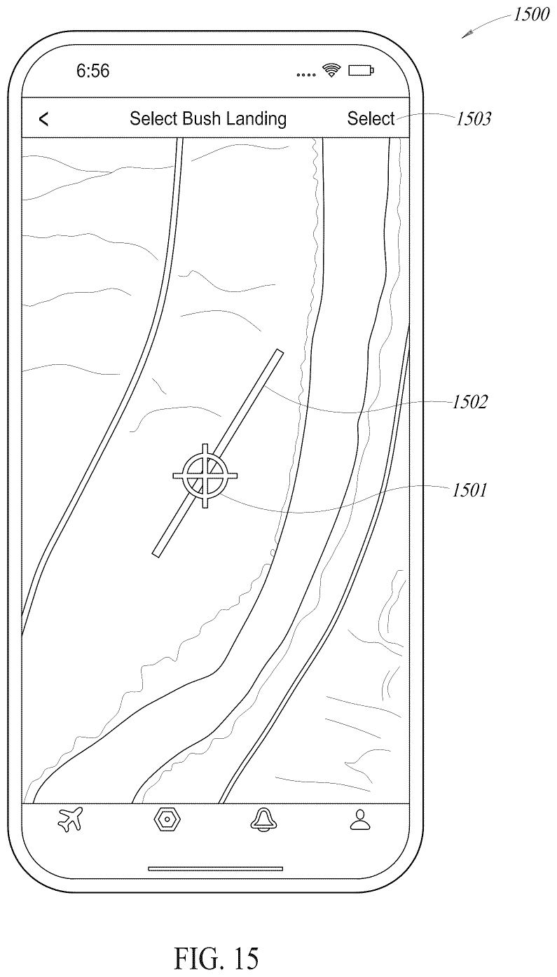

The process for identifying off-airport landing areas 1400 may begin, after a start block, at act 1401, where the application receives input from a user indicating an off-airport landing area. In some embodiments, the user input is received via the user interface for selecting off-airport landing areas, such as the user interface described below in connection with FIG. 15.

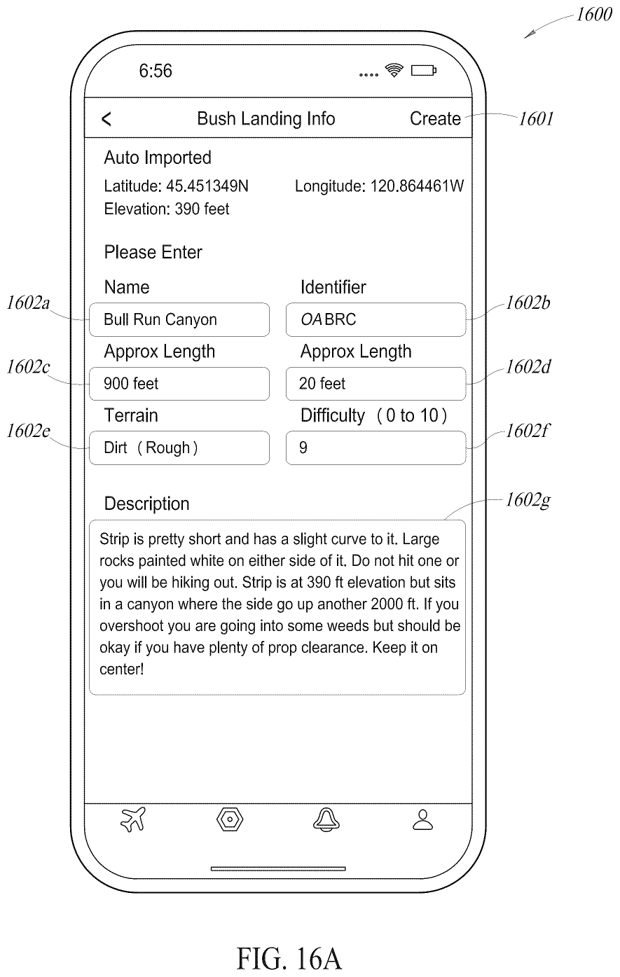

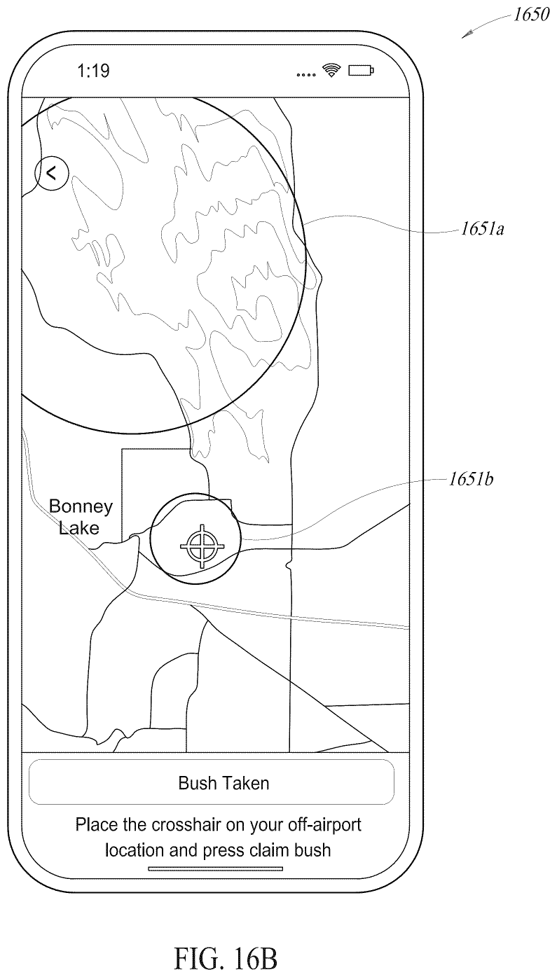

The process for identifying off-airport landing areas 1400 may proceed to act 1402, where the application receives an indication of off-airport landing data via user input. In some embodiments, the indication of off-airport landing data is received via the user interface for inputting off-airport landing data, such as the user interface described below in connection with FIG. 16.

The process for identifying off-airport landing areas 1400 may proceed to act 1403, where the application updates a repository of off-airport landing area information maintained, managed, accessed, updated, or otherwise used by the social media service.

The process for identifying off-airport landing areas 1400 may proceed to act 1404, where the application causes the one or more off-airport landing areas to be displayed to one or more other users. In some embodiments, information regarding the off-airport landing areas are displayed to one or more other users in response to a request by the one or more other users to view information regarding off-airport landing areas.

After displaying the off-airport landing areas to one or more other users, the process for identifying off-airport landing areas 1400 ends.

FIG. 15 is a display diagram of a user interface for selecting an off-airport landing area 1500, according to various embodiments described herein. The user interface for selecting an off-airport landing area 1500 includes a target user interface component 1501 that indicates a geographic location of the off-airport landing area 1502 and a select icon 1503. In some embodiments, the target 1501 remains in the center of the user interface 1500 while the map is moved via interaction with the user interface 1500. In some embodiments, interacting with the select icon 1503 causes an application to present a user interface for inputting off-airport landing information 1600, such as the user interface described below in connection with FIG. 16A.

FIG. 16A is a display diagram of a user interface for inputting off-airport landing areas 1600 according to various embodiments described herein. The user interface for inputting off-airport landing areas 1600 includes a create icon 1601 and one or more user interface components for inputting information regarding the off-airport landing area 1602a-1602g (collectively “user interface components for inputting information regarding the off-airport landing area 1602”). Interacting with the one or more user interface components for inputting information regarding the off-airport landing area 1602 may enable a user to input a name of the off-airport landing area, an identifier for the off-airport landing area, an approximate length of the off-airport landing area, an approximate width of the off-airport landing area, a terrain of the off-airport landing area, a difficulty rating for the off-airport landing area, a description of the off-airport landing area, or some combination thereof. Interacting with the create icon 1601 enables a user to indicate to the social media service that an off-airport landing area is to be created based on data input into the one or more user interface components for inputting information regarding the off-airport landing area 1602.

FIG. 16B is a display diagram of a second user interface for selecting an off-airport landing area 1650, according to various embodiments described herein. The second user interface for selecting an off-airport landing area 1650 may operate similarly to the first user interface for selecting the off-airport landing area 1600 described above in connection with FIG. 16A. The second user interface for selecting an off-airport landing area 1650 may include an indication of one or more radii 1651a and 1651b (collectively “radii 1651” or individually radius 1651) around one or more previously entered off-airport landing areas. In some embodiments, the radius 1651 is indicated via a red circle drawn on the map included in the second user interface for selecting an off-airport landing area 1650. In some embodiments, aspects of the social media service determine the radius 1651 based on one or more dimensions of the landing strip a the off-airport landing area, such as the length, width, or some combination thereof. In some embodiments, a user is prevented from entering a new off-airport landing area at a point on the map indicated by the radii around the one or more previously entered off-airport landing areas.

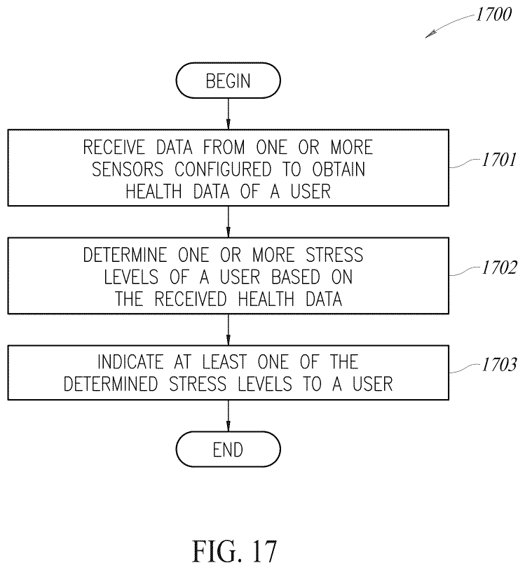

FIG. 17 is a process for stress tracking during a flight track 1700, according to various embodiments described herein. Aspects of the social media service for airplane pilots, such as an application associated with the social media service, may perform the process for stress tracking during a flight track 1700, according to various embodiments described herein. Any aspect of the social media service for airplane pilots, such as a server, smartphone, application, wearable device, or other device associated with an aspect of the social media service, may perform any one or more of the acts described with respect to the process for stress tracking 1700.

The process for stress tracking 1700 may begin, after a start block, at act 1701, where the application receives data from one or more sensors configured to obtain health data of a user. In some embodiments, at least a portion of the one or more sensors are included in a wearable device worn by the user while the user is flying along a flight track. In some embodiments, the health data is identified based on a time at which the user was flying along the flight track obtained via flight data.

The process for stress tracking 1700 may proceed to act 1702, where the application determines one or more stress levels of the user based on the received health data. In some embodiments, the one or more stress levels include an indication of a heart rate of the user.

The stress being experienced by the pilot may be measured and reported in one or more various ways. One measure of stress can be the heart beat rate as measured in beats per minute, while another measure can be the change in heart rate from a first rate to a second rate and yet another can be the time period over which the heart rate changes, for example a rapid change from a low rate to a high rate over a few seconds as compared to a gradual change that extends over several minutes, for example, a rise that happens slowly over 10 to 15 minutes. Other ways to measure stress include blood pressure, general perspiration, specific perspiration, for example on the hands only or forehead only when the rest of the body is otherwise cool and not perspiring. Any known way to measure stress is acceptable.

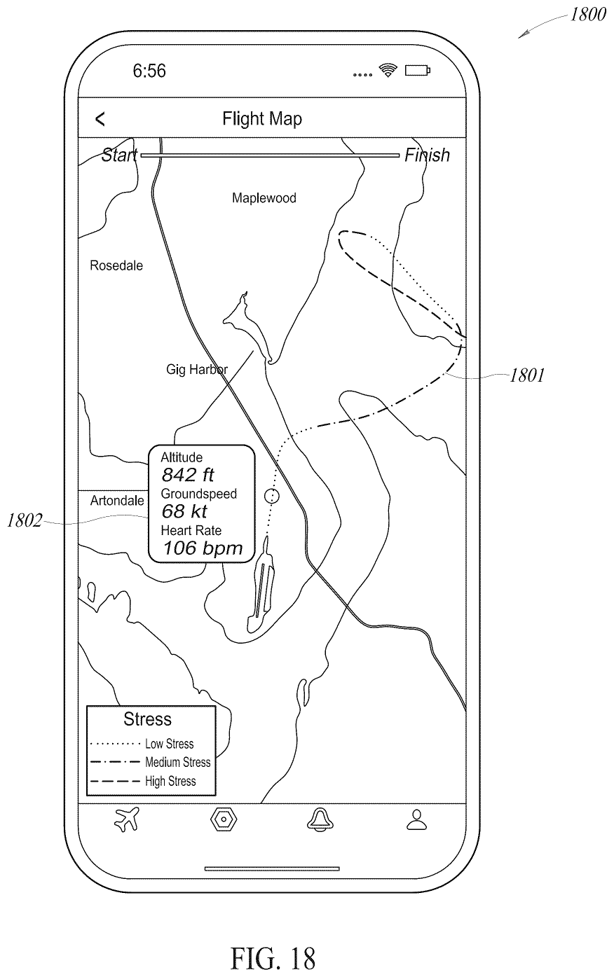

The process for stress tracking 1700 may proceed to act 1703, where the application indicates the one or more stress levels to the user. In some embodiments, the one or more stress levels are indicated to the user via one or more user interface components placed on the flight track based on the time at which the stress level occurred, such as via the user interface for stress tracking 1800 described below in connection with FIG. 18. The stress level at different times and during different parts of the flight can be viewed by other pilots to give them an understanding of various factors that occurred during this particular flight. They can easily see if the stress occurred at take-off, just before take-off, at landing, just after landing, just before landing or at one times during mid-flight. In addition, the pilot or others can compare the stress level to the occurrence of different live flight factors.

After indicating the one or more stress levels, the process for stress tracking 1700 ends.

FIG. 18 is a user interface for displaying stress tracking on a flight map 1800, according to various embodiments described herein. The user interface for displaying stress tracking on a flight map may include a flight track 1801 and a user interface component for displaying a stress level at a point on the flight track 1802. The stress can be displayed in one or more different ways in graphic form. In some embodiments, low stress will be indicated by coloring a portion of the flight path green, a green dot positioned along the flight track, etc. As the stress increases, the color may change to yellow, then red, the purple, for either a portion of the flight track or a dot placed on the flight track. Interacting with the user interface component for displaying the stress level 1800 may enable a user to view one or more measures of the stress level of the user at a point in the flight track, such as a heart rate.

As indicated by FIG. 18, the flight track 1801 changes from dots to dots-and-dashes to dashes to represent the colors used to display the stress experienced by a user. In this example, the dotted portion of the flight track 1802 indicates a low stress portion of the flight, the dot-and-dash portion of the flight track 1802 indicates a medium stress portion of the flight, and the dashed portion of the flight track 1802 indicates a high stress portion of the flight.

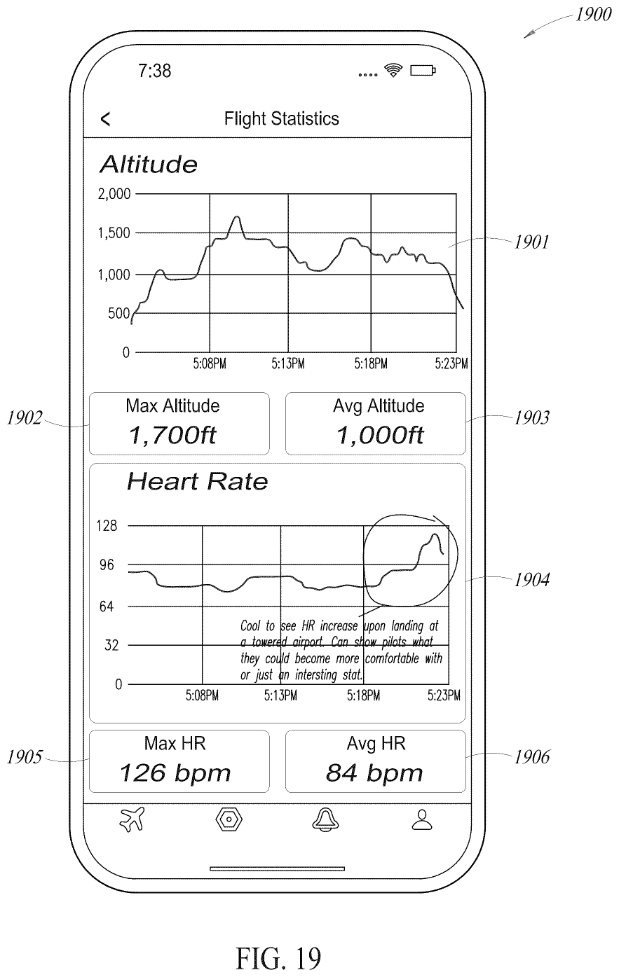

FIG. 19 is a display diagram of a stress tracking statistics page 1900 displayed to a user, according to various embodiments described herein. The stress tracking statistics page 1900 includes an altitude graph 1901, a max altitude indicator 1902, an average altitude indicator 1903, a heart rate graph 1904, a max heart rate indicator 1905, and an average heart rate indicator 1906. The altitude graph 1901 and heart rate graph 1904 are each graphs that correspond to flight data and heart rate data respectively during the period of time that the flight track occurs. The max altitude indicator 1902 and average altitude indicator 1903 indicate the maximum altitude and average altitude of an airplane that flew according to a generated flight track. The max heart rate indicator 1905 and average heart rate indicator 1906 indicate the maximum and average heart rate experienced by a user while flying along the flight track.

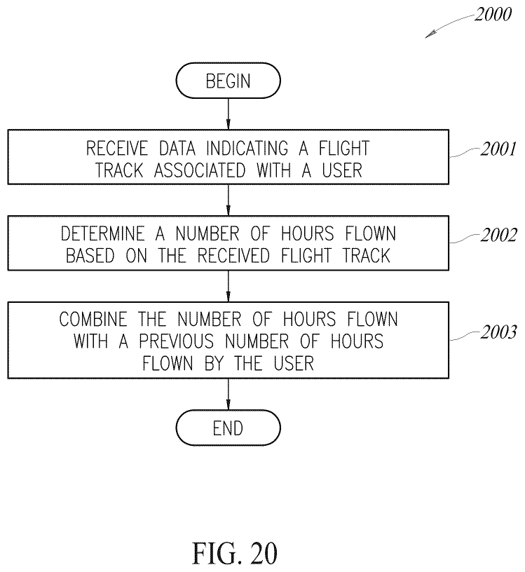

FIG. 20 is a flow diagram of a sample process for updating flight hours 2000, according to various embodiments described herein. Aspects of the social media service for airplane pilots, such as an application associated with the social media service, may perform a process for updating flight hours 2000, according to various embodiments described herein. Any aspect of the social media service for airplane pilots, such as a server, smartphone, application, wearable device, or other device associated with an aspect of the social media service, may perform any one or more of the acts described with respect to the process for updating flight hours 2000.

The process for updating flight hours 2000 may begin, after a start block, at act 2001, where the application receives data indicating a flight track, such as a flight track generated via the process for transmitting a social media post described above.

The process for updating flight hours 2000 may proceed to act 2002, where the application determines a number of hours flown based on the received flight track.

The process for updating flight hours 2000 may proceed to act 2003, where the application combines the determined number of hours flown with a previous number of hours flown by the user.

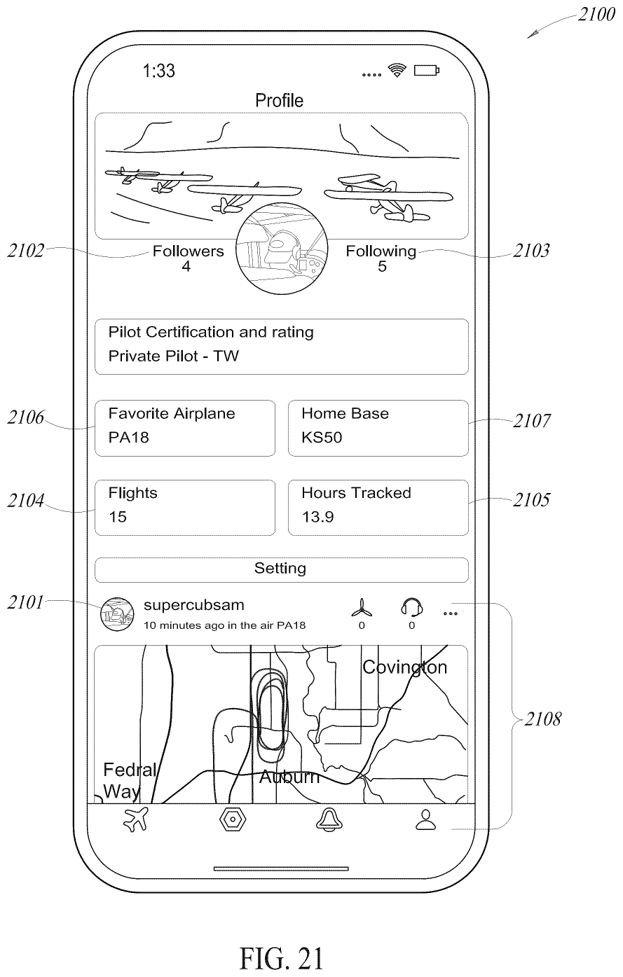

After combining the determined number of hours flown with the previous number of hours flown, the process for updating flight hours 2000 ends. In some embodiments, the updated flight hours are displayed in the user interface indicating a profile of the user, such as the user interface described below in connection with FIG. 21.

FIG. 21 is a display diagram of a user interface indicating a user profile 2100, according to various embodiments described herein. The user interface indicating a user profile 2100 may include user interface components indicating a name of the profile, a follower and following count of the user, a favorite airplane of the user, a number of flights flown by the user, a number of hours flown by the user, a home airport of the user, one or more posts generated by the user, other aspects of a user profile, or some combination thereof.

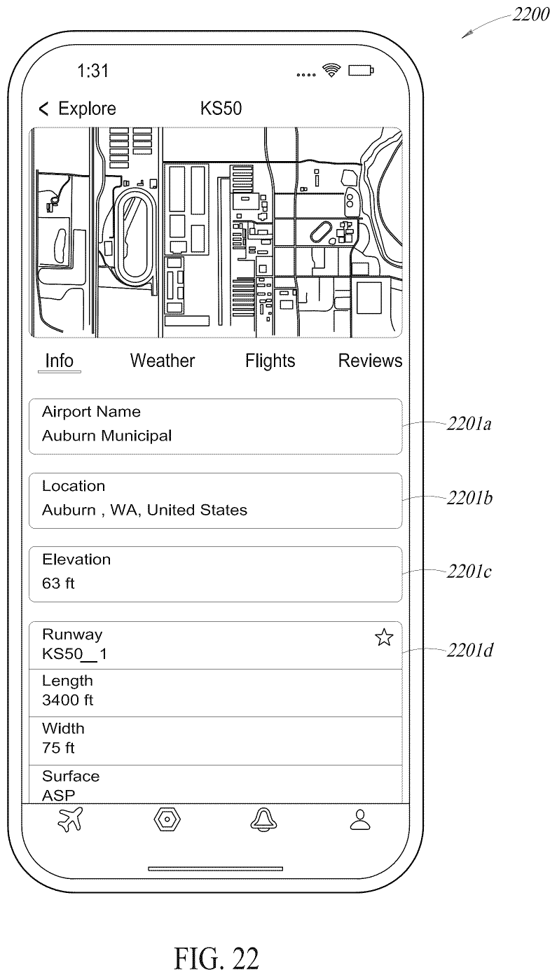

FIG. 22 is a display diagram of an airport data page 2200, according to various embodiments described herein. The airport data page 2200 may include user interface components indicating attributes of a selected airport 2201a-2201d (collectively as “user interface components indicating attributes of a selected airport 2201”), such as a name, elevation, location, etc., of the airport, the weather at the airport, flights to and from the airport, reviews of the airport, or some combination thereof.

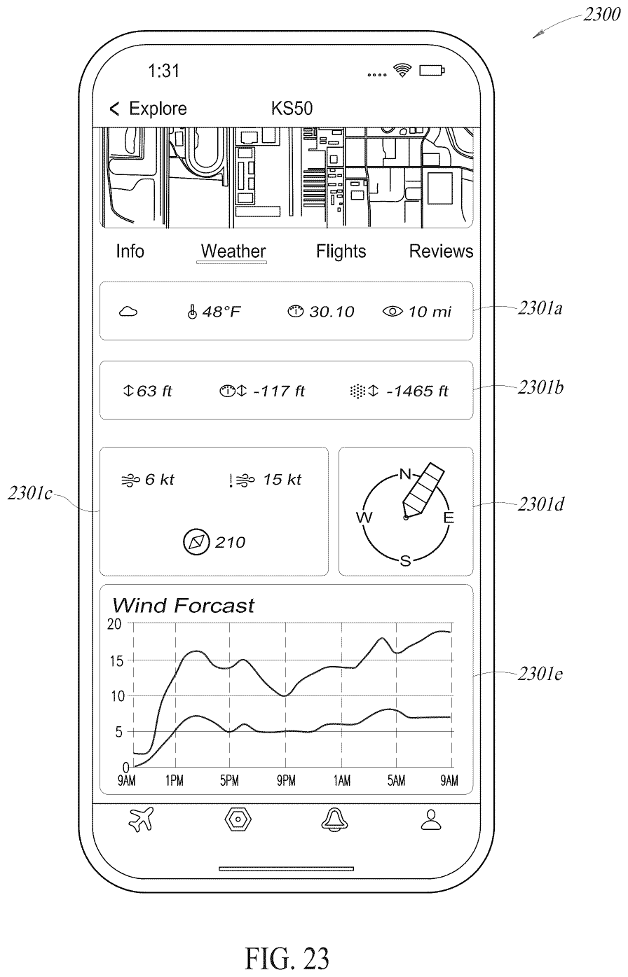

FIG. 23 is a display diagram of an airport weather page 2300, according to various embodiments described herein. The airport weather page 2300 includes one or more user interface components indicating the current weather conditions at an airport 2301a-2301e (collectively as “user interface components 2301”), such as a temperature, barometric pressure, wind speed, wind direction, sight range, other weather data, weather forecasts for the geographic area within which the airport is located, or some combination thereof. In some embodiments, the airport weather page includes a user interface component depicting a windsock, such as the user interface component 2301d. In such embodiments, the windsock may indicate a direction of the wind at the airport. In some embodiments, the length of the windsock may change based on the windspeed at the airport.

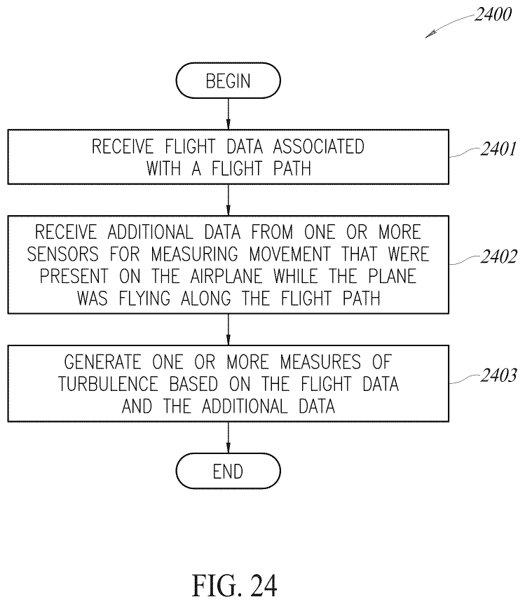

FIG. 24 is a sample flow diagram of a process for identifying turbulence experienced during a flight path 2400, according to various embodiments described herein. Aspects of the social media service for airplane pilots, such as an application associated with the social media service, may perform the process for identifying turbulence experienced during a flight path 2400, according to various embodiments described herein. Any aspect of the social media service for airplane pilots, such as a server, smartphone, application, wearable device, or other device associated with an aspect of the social media service, may perform any one or more of the acts described with respect to the process for identifying turbulence 2400.

The process for identifying turbulence 2400 may begin, after a start block, at act 2401, where an application receives flight data associated with a flight path, such as in a similar manner to receiving flight data as part of the process for transmitting a social media post described above.

The process for identifying turbulence 2400 may proceed to act 2402, where the application receives additional data from a sensor for measuring movement that was present on an airplane that flew along the flight path. In some embodiments, the sensor may be one or more of a sensor of a wearable device, a sensor of a smartphone, a sensor that generates gyroscope data, a sensor that generates accelerometer data, another sensor that measures movement, or some combination thereof. In some embodiments, the additional data may include other data useful for measuring turbulence.

The process for identifying turbulence 2400 may proceed to act 2401, where the application generates one or more measure of the turbulence experienced while the plane flew along the flight path based on the flight data and the additional data. In some embodiments, the measures of turbulence are generated for one or more times during which the airplane was flying along the flight path.

The process for identifying turbulence 2400 may end after generating the one or more measures of the turbulence. In some embodiments, one or more measures of the turbulence are displayed within a post, such as by including indicators on a flight map of locations at which turbulence was experienced.

The turbulence may be displayed in one or more different ways in graphic form for ease of viewing by other pilots. Knowing the location and strength of turbulence can be an importance aspect of safe flying. Therefore, the details of turbulence are displayed in a way that another pilot can see at a glance the exact location and strength of the turbulence. In one embodiment, all locations of low turbulence will be green flight path. For greater turbulence, the color can change to yellow, if higher, to a purple, and if the highest to a red or black color the flight path. It can also be a dot of particular color at the location in which turbulence was encountered along the flight path, the no dot meaning no turbulence and then dots being provided, with number of the dots, whether 1, 2, 3, etc. or the color of the dot, whether green, blue, purple, red, black indicating increasing levels of turbulence.

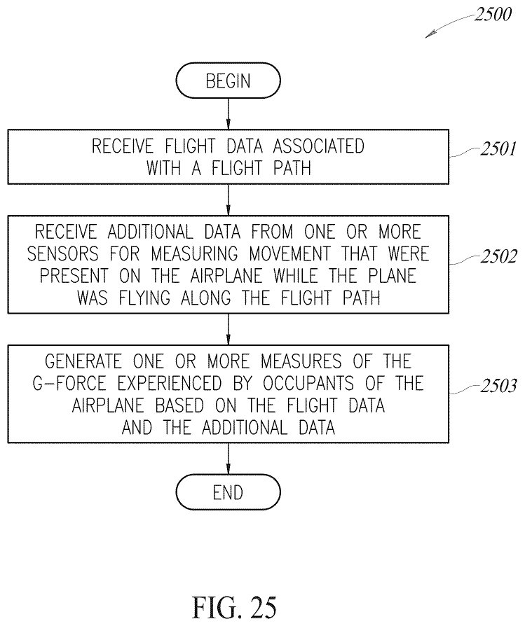

FIG. 25 is a sample flow diagram of a process for identifying the G-Force experienced by occupants of an airplane during a flight path 2500, according to various embodiments described herein. Aspects of the social media service for airplane pilots, such as an application associated with the social media service, may perform a process for identifying the G-Force experienced by occupants of an airplane during a flight path 2500, according to various embodiments described herein. Any aspect of the social media service for airplane pilots, such as a server, smartphone, application, wearable device, or other device associated with an aspect of the social media service, may perform any one or more of the acts described with respect to the process for identifying G-Force 2500.

The process for identifying G-Force 2500 may begin, after a start block, at act 2501, where the application receives flight data associated with a flight path, such as in a similar manner to receiving flight data as part of the process for transmitting a social media post described above.

The process for identifying G-Force 2500 may proceed to act 2502, where the application receives additional data from a sensor for measuring movement that was present on an airplane that flew along the flight path. In some embodiments, the sensor may be one or more of a sensor of a wearable device, a sensor of a smartphone, a sensor that generates gyroscope data, a sensor that generates accelerometer data, another sensor that measures movement, or some combination thereof. In some embodiments, the additional data may include other data useful for measuring G-Force.

The process for identifying G-Force 2500 may proceed to act 2503, where the application generates one or more measures of the G-Force experienced by occupants of the airplane while the airplane flew along the flight path based on the flight data and the additional data. In some embodiments, the one or more measures of the G-Force are generated for one or more times at which the airplane traveled along the flight path. In some embodiments, to generate the one or more measures of the G-Force experienced by occupants of the airplane, one or more flight maneuvers are identified based on the flight data. In such embodiments, the flight maneuvers may be identified based on a latitude, longitude, altitude, speed, or some combination thereof of the airplane. For example, the altitude, latitude, and longitude may indicate that the airplane performed a loop, a cobra maneuver, or other maneuvers.

The process for identifying G-Force 2500 may end after generating the one or more measures of the G-Force. In some embodiments, the G-Force data is displayed in a post, such as by including one or more indicators of the G-Force experienced by occupants of the airplane on a flight map.

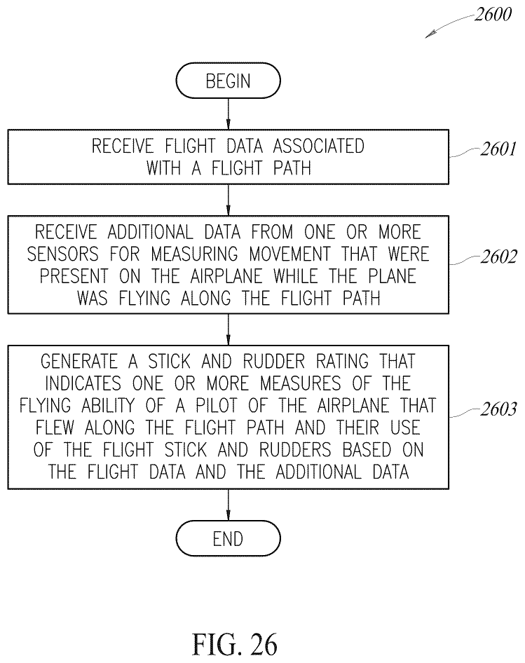

FIG. 26 is a sample flow diagram of a process for identifying a stick and rudder rating for a pilot 2600, according to various embodiments described herein. Aspects of the social media service for airplane pilots, such as an application associated with the social media service, may perform a process for identifying a stick and rudder rating for a pilot 2600, according to various embodiments described herein. Any aspect of the social media service for airplane pilots, such as a server, smartphone, application, wearable device, or other device associated with an aspect of the social media service, may perform any one or more of the acts described with respect to the process for identifying a stick and rudder rating 2600. In some embodiments, the stick and rudder rating is a measure of the flying ability of the pilot.

The process for identifying a stick and rudder rating 2600 may begin, after a start block, at act 2601, where the application receives flight data associated with a flight path, such as in a similar manner to receiving flight data as part of the process for transmitting a social media post described above.

The process for identifying stick and rudder rating 2600 may proceed to act 2602, where the application receives additional data from a sensor for measuring movement that was present on an airplane that flew along the flight path. In some embodiments, the sensor may be one or more of a sensor of a wearable device, a sensor of a smartphone, a sensor that generates gyroscope data, a sensor that generates accelerometer data, another sensor that measures movement, or some combination thereof. In some embodiments, the additional data may include other data useful for generating a stick and rudder rating.

The process for identifying a stick and rudder rating 2600 may proceed to act 2603, where the application generates a stick and rudder rating that indicates one or more measures of the flying ability of the pilot and their use of the flight stick and rudders while the plane flew along the flight path based on the flight data and the additional data. In some embodiments, the stick and rudder rating is generated for one or more times during which the airplane was flying along the flight path.

The process for identifying a stick and rudder rating 2600 may end after generating the stick and rudder rating. In some embodiments, stick and rudder rating is displayed in a post, such as by including indicators of locations on the flight path at which the stick and rudder rating changed.

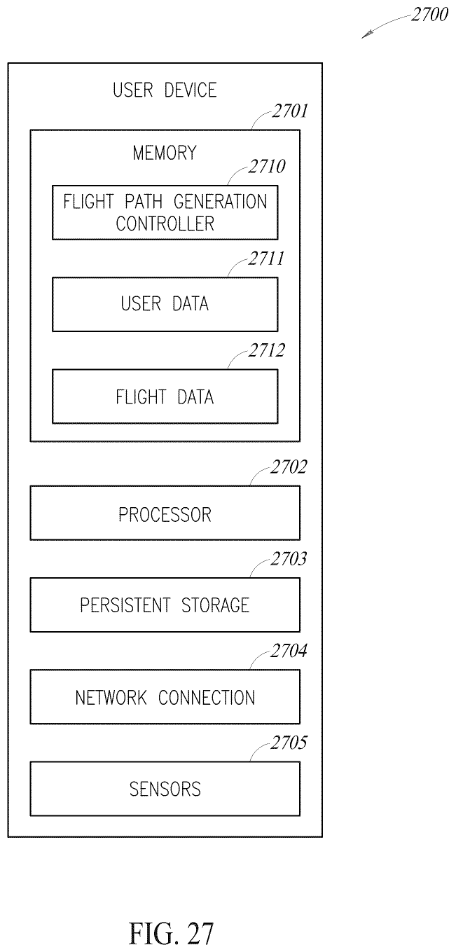

FIG. 27 is a block diagram of an example user device 2700, according to various embodiments described herein. The user device may include a memory 2701, a processor 2702, persistent storage 2703, a network connection interface 2704, and one or more sensors 2705. The memory may include a flight path generation controller 2710, user data 2711, and flight data 2712. The one or more sensors 2705 may include an accelerometer, a gyroscope, health data sensors, or other sensors that may be used to obtain data used by the embodiments described herein. The flight path generation controller 2710, user data 2711, and flight data 2712 may be accessed, included in, or otherwise used by, an application associated with the social media service to perform any of the functions described herein. The network connection 2704 may be used to access one or more computer networks.

The memory 2701 may be used for storing programs and data while they are being used, including data associated with the user, flight path, airplanes, airports, social media service, other data associated with a user or the social media service, an operating system including a kernel device drivers, or some combination thereof that are not shown since their generation and use would be well within the ability of a person of ordinary skill in the art. The processor 2702 may be used for executing computer programs (not shown since their generation and use would be well within the ability of a person of ordinary skill in the art), such as computer programs which perform some or all of the functions of the application, social media service, or some combination thereof. In some embodiments, the processor 2702 may be one or more processors, microcontrollers, or other computer components. In some embodiments, any of the processors, microcontrollers, or other computer components, either alone or in combination, can perform any of the functions or acts described herein. The persistent storage device 203 may be a hard drive or flash drive for persistently storing programs and data. The network connection 204 may be used for connecting to one or more flight data repositories that are at a remote location or in the cloud (not shown); one or more aspects of the social media service; other computing devices, data repositories, etc., associated with the social media service or its functions; or some combination thereof, to send or receive data, such as via the Internet or another network and associated networking hardware, such as switches, routers, repeaters, electrical cables and optical fibers, light emitters and receivers, radio transmitters and receivers, and the like, and to scan for and retrieve signals associated with client devices, access points, devices or components associated with the network. In various embodiments, the user device 2700 additionally includes input and output devices, such as a keyboard, a mouse, display devices, etc.

While a user device 2700 configured as described may be used in some embodiments, in various other embodiments, the user device 2700 may be implemented using devices of various types and configurations and having various components. The memory 2701 may include a flight path generation controller 2710, which contains computer-executable instructions that, when executed by the processor 2702, cause the user device 2700 to perform the operations and functions described herein. For example, the programs referenced above, which may be stored in computer memory 2701, may include or be comprised of such computer-executable instructions. The memory 2701 may also include user data 2711, which includes data related to a user of the user device, flight data 2712, which flight data associated with the user, or some combination thereof.

The flight path generation controller 2710 performs at least some of the core functions of the social media service, as discussed herein and also with respect to FIGS. 1-26. In some embodiments, the flight path generation controller 2710 performs at least some of the aspects of the processes 200, 600, 700, 900, 1000, 1100, 1200, 1300, 1400, 1700, 2000, 2400, 2500, and 2600. In some embodiments, the flight path generation controller 2710 generates at least a portion of one or more of the user interfaces 100, 300, 400, 500, 800, 1500, 1600, 1800, 1900, 2100, 2200, and 2300.

In an example embodiment, the flight data generation controller 2710 or computer-executable instructions stored on memory 2701 of the user device 2700 are implemented using standard programming techniques. For example, the flight data generation controller 2710 or computer-executable instructions stored on memory 2701 of the user device 2700 may be implemented as a “native” executable running on processor 2702, along with one or more static or dynamic libraries. In other embodiments, the flight data generation controller 2710 or computer-executable instructions stored on memory 2701 of the user device 2700 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the flight data generation controller 2710.

In addition, programming interfaces to the data stored as part of the flight data generation controller 2710 can be available by standard mechanisms such as through C, C++, C#, Java, and web APIs; libraries for accessing files, databases, or other data repositories; through scripting languages such as JavaScript and VBScript; or through Web servers, FTP servers, or other types of servers providing access to stored data. The flight data generation controller 2710 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the user device 2710.

Furthermore, in some embodiments, some or all of the components/portions of the flight data generation controller 2710, or functionality provided by the computer-executable instructions stored on memory 2701 of the user device 2700 may be implemented or provided in other manners, such as at least partially in firmware or hardware, including, but not limited to, one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer-readable medium (e.g., as a hard disk; a memory; a computer network or cellular wireless network; or a portable media article to be read by an appropriate drive or via an appropriate connection, such as a DVD or flash memory device) so as to enable or configure the computer-readable medium or one or more associated computing systems or devices to execute or otherwise use or provide the contents to perform at least some of the described techniques. Such computer program products may also take other forms in other embodiments. Accordingly, embodiments of this disclosure may be practiced with other computer system configurations.

In general, a range of programming languages may be employed for implementing any of the aspects of the social media service present in the example embodiments, including representative implementations of various programming language paradigms and platforms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

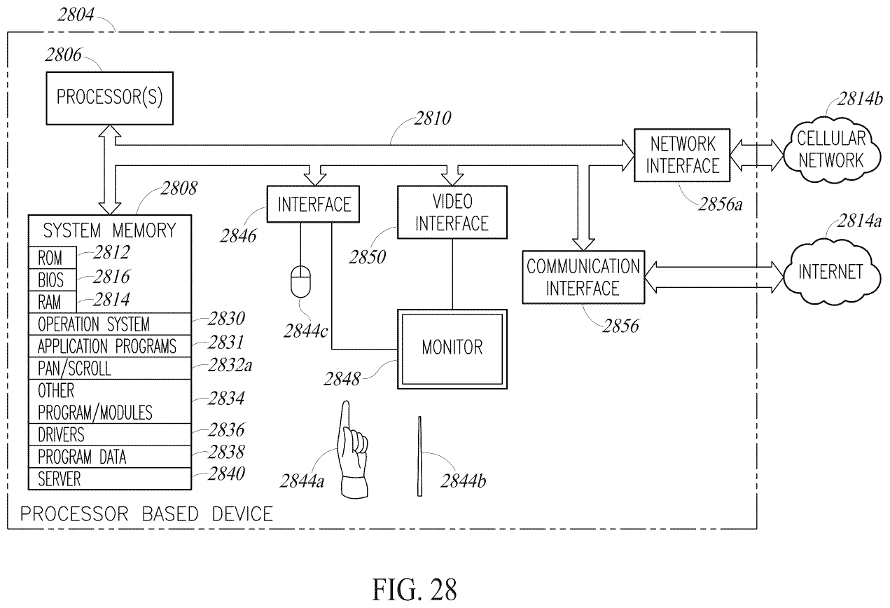

FIG. 28 is a display diagram of a sample server 2800 associated with the social media service, according to various embodiments described herein. The server may be used to perform one or more aspects of the various embodiments described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The server 2804 may include one or more processors 2806, a system memory 2808 and a system bus 2810 that couples various system components including the system memory 2808 to the processor(s) 2806. The server 2804 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 2806 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 28 are of conventional design. As a result, such blocks need not be described in further detail herein, as they will be understood by those skilled in the relevant art.

The system bus 2810 can employ any known bus structures or architectures, including a memory bus with memory controller, a peripheral bus, and a local bus. The system memory 2808 includes read-only memory (“ROM”) 2812 and random access memory (“RAM”) 2814. A basic input/output system (“BIOS”) 2816, which can form part of the ROM 2812, contains basic routines that help transfer information between elements within server 2804, such as during start-up. Some implementations may employ separate buses for data, instructions and power.

The server 2804 may also include one or more solid state memories, for instance Flash memory or solid state drive (SSD) 2818, which provides nonvolatile storage of computer-readable instructions, data structures, program modules and other data for the server 2804. Although not depicted, the server 2804 can employ other nontransitory computer-or processor-readable media, for example a hard disk drive, an optical disk drive, or memory card media drive.

Program modules can be stored in the system memory 2808, such as an operating system 2830, one or more application programs 2832, other programs or modules 2834, drivers 2836 and program data 2838.

The application programs 2832 may, for example, include panning/scrolling 2832a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 2832a may, for example, be stored as one or more executable instructions. The panning/scrolling logic 2832a may include processor and/or machine executable logic or instructions to generate user interface objects using data that characterizes movement of a pointer, for example data from a touch-sensitive display or from a computer mouse or trackball, or other user interface device.

The system memory 2808 may also include communications programs 2840, for example a server and/or a Web client or browser for permitting the server 2804 to access and exchange data with other systems such as user computing systems, Web sites on the Internet, corporate intranets, or other networks as described below. The communications programs 2840 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 28 as being stored in the system memory 2808, the operating system 2830, application programs 2832, other programs/modules 2834, drivers 2836, program data 2838 and server and/or browser 2840 can be stored on any other of a large variety of nontransitory processor-readable media (e.g., hard disk drive, optical disk drive, SSD and/or flash memory).

A user can enter commands and information via a pointer, for example through input devices such as a touch screen 2848 via a finger 2844a, stylus 2844b, or via a computer mouse or trackball 2844c which controls a cursor. Other input devices can include a microphone, joystick, game pad, tablet, scanner, biometric scanning device, etc. These and other input devices (i.e., “I/O devices”) are connected to the processor(s) 2806 through an interface 2846 such as touch-screen controller and/or a universal serial bus (“USB”) interface that couples user input to the system bus 2810, although other interfaces such as a parallel port, a game port or a wireless interface or a serial port may be used. The touch screen 2848 can be coupled to the system bus 2810 via a video interface 2850, such as a video adapter to receive image data or image information for display via the touch screen 2848. Although not shown, the server 2804 can include other output devices, such as speakers, vibrator, haptic actuator, etc.

The server 2804 may operate in a networked environment using one or more of the logical connections to communicate with one or more remote computers, servers and/or devices via one or more communications channels, for example, one or more networks 2814a, 2814b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the server 2804 may include one or more wired or wireless communications interfaces 2814a, 2814b (e.g., cellular radios, WI-FI radios, Bluetooth radios) for establishing communications over the network, for instance the Internet 2814a or cellular network.

In a networked environment, program modules, application programs, or data, or portions thereof, can be stored in a server computing system. Those skilled in the relevant art will recognize that the network connections shown in FIG. 28 are only some examples of ways of establishing communications between computers, and other connections may be used, including wirelessly.

For convenience, the processor(s) 2806, system memory 2808, network and communications interfaces 2814a, 2814b are illustrated as communicably coupled to each other via the system bus 2810, thereby providing connectivity between the above-described components. In alternative implementations of the server 2804, the above-described components may be communicably coupled in a different manner than illustrated in FIG. 28. For example, one or more of the above-described components may be directly coupled to other components, or may be coupled to each other, via intermediary components that are not all shown. In some implementations, system bus 2810 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The embodiments described above may also use synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the network social media service.

In addition, programming interfaces to the data used by aspects of the social media service can be available by standard mechanisms such as through C, C++, C#, Java, and web APIs; libraries for accessing files, databases, or other data repositories; through scripting languages such as JavaScript and VBScript; or through Web servers, FTP servers, or other types of servers providing access to stored data. The functions of the social media service may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the social media service.

In general, a range of programming languages may be employed for implementing any of the functionality of the client devices, access points, interface mitigation system, interfering devices, etc., present in the example embodiments, including representative implementations of various programming language paradigms and platforms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

The various embodiments described above can be combined to provide further embodiments. Aspects of the embodiments can be modified, if necessary to employ concepts of various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
a display;
at least one processor; and
at least one memory coupled to the at least one processor, the memory having computer-executable instructions stored thereon that, when executed by the at least one processor, cause the system to:
receive an indication of an airplane associated with a user;
receive an indication of flight data from one or more flight data repositories based on the indicated airplane;
identify one or more airports based on the flight data;
generate a flight path based on the identified one or more airports, the flight data, and the indicated airplane;
receive an indication of descriptive data regarding the flight path;
cause the display to visually display a pattern showing an indication of the flight path and an indication of the descriptive data to the user on a first user device; and
cause the flight path and the descriptive data to be stored for transmission to a second user device.

2. The system of claim 1, wherein, to cause the flight path and descriptive data to be stored for transmission to the second user device, the computer-executable instructions further causes the system to:
transmit data indicating the flight path and the descriptive data to a server configured to distribute the flight path and descriptive data to one or more user devices.

3. The system of claim 1, wherein, to generate the flight path, the computer-executable instructions further causes the system to:
receive an indication of a departure airport and a destination airport;
identify a starting time for the flight path based on the flight data and the departure airport;
identify an ending time for the flight path based on the flight data and the destination airport;
identify one or more intermediate airports based on the starting time for the flight path, the ending time for the flight path, and the flight data;
generate the flight path based on the departure airport, the destination airport, the starting time, the ending time, and the one or more intermediate airports.

4. The system of claim 1, wherein the computer-executable instructions further cause the system to:
identify at least one instance of content based on the indicated airplane, the flight path, the one or more airports, or the user associated with the indicated airplane; and
cause the display to display the at least one instance of content.

5. The system of claim 1, wherein, to receive the indication of flight data, the computer-executable instructions further cause the system to:
detect that the indicated airplane has taken off from or landed at an airport; and
in response to detecting that the indicated airplane has taken off from or landed at an airport, transmit a request for flight data to a flight repository.

6. The system of claim 1, wherein, the flight data includes flight data for two or more flights, and wherein to generate the flight path, the computer-executable instructions further cause the system to:
receive an indication of two or more stops via user input;
receive an indication of an order of the two or more stops via user input; and
generate a flight track based on the indication of flight data, the indication of two or more stops, and the indication of the order of the two or more stops.

7. The system of claim 1, wherein the flight data includes data indicating one or more of:
at least one latitude;
at least one longitude;
at least one altitude; or
at least one groundspeed.

8. The system of claim 1, wherein the computer-executable instructions further cause the system to:
identify a user of the second user device;
identify an airport ribbon display setting associated with the user of the second user device;
identify one or more airports indicated by the flight path; and
cause an airport ribbon to be displayed on the second user device based on the identified one or more airports and the airport ribbon display setting.

9. The system of claim 1, wherein the computer-executable instructions further cause the system to:
cause the second user device to display a post based on the flight path and descriptive data, wherein the post includes a user interface component indicating that the user of the second user device has interacted with the post;
determining whether the user of the second user device has interacted with the post; and
based on a determination that the user of the second user device has interacted with the post, causing the user interface component indicating that the user of the second user device has interacted with the post to move.

10. The system of claim 1, wherein the computer-executable instructions further cause the system to:
cause the second user device to display a post based on the flight path and descriptive data, wherein the post includes a representation of the flight path, and wherein the representation of the flight path includes an indication of one or more of:
a starting point of the flight path;
an ending point of the flight path;
a groundspeed of an airplane that flew along the flight path;
a crosswind experienced by an airplane that flew along the flight path;
a turbulence experienced by an airplane that flew along the flight path;
a g-force experienced by an airplane that flew along the flight path;
a time of day during which an airplane flew along the flight path;
a stop made by an airplane that flew along the flight path; or
a radio call made by an occupant of an airplane that flew along the flight path.

11. The system of claim 1, wherein the representation of the flight path includes two or more colors.

12. The system of claim 11, wherein, to display the post, the computer-executable instructions further cause the system to:
receive an indication that a user of the second user device is color-blind; and
select the two or more colors based on the indication that the user of the second user device is color-blind.

13. The system of claim 1, wherein the computer-executable instructions further cause the system to:
receive flight data associated with the flight path;
receive additional data from one or more sensors for measuring movement that were present on the airplane while the airplane was flying along the flight path;
generate a score indicating the proficiency of a pilot of the airplane based on the flight data and the additional data.

14. The system of claim 1, wherein the flight data includes data generated by one or more of:
a global-positioning-system device;
an automatic dependent surveillance broadcasting device;
a wearable user device; and
a black box of the airplane.

15. The system of claim 1, wherein the computer-executable instructions further cause the system to:
receive input indicating an off-airport landing area;
receive an indication of off-airport landing data;
update a repository of off-airport landing area information based on the indication of off-airport landing data and the indicated off-airport landing area; and
display one or more off-airport landing areas to one or more users.

16. The system of claim 1, wherein the computer-executable instructions further cause the system to:
receive health data from one or more sensors configured to obtain health data for the user;
determine one or more stress levels of the user based on the received health data; and
indicate at least one of the determined stress levels to a user.

17. The system of claim 1, wherein, to generate the flight path, the computer-executable instructions further cause the system to:
detect that the flight data does not include data for one or more locations at which the airplane flew during a flight; and
extrapolate flight data for the airplane based on at least a portion of the flight data; and
combine the flight data and the extrapolated flight data to obtain final flight data includes flight data for the one or more locations for which data was detected as not included.

18. The system of claim 1, wherein, to receive the indication of flight data, the computer-executable instructions further cause the system to:
receive flight data associated with the flight path;
receive additional data from one or more sensors for measuring movement that were present on the airplane while the airplane was flying along the flight path; and
generate, based on the flight data and the additional data, one or more measures of at least one of: turbulence experienced by occupants of the airplane or a g-force experienced by occupants of the airplane.

19. A non-transitory computer-readable medium having contents configured to cause at least one processor to perform a method comprising:
receive an indication of an airplane associated with a user;
receive an indication of flight data from one or more flight data repositories based on the indicated airplane;
identify one or more airports based on the flight data;
generate a flight path based on the identified one or more airports, the flight data, and the indicated airplane;
receive an indication of descriptive data regarding the flight path;
visually display a pattern showing an indication of the flight path and an indication of the descriptive data to the user on a first user device; and
cause the flight path and the descriptive data to be stored for transmission to a second user device.

20. A method comprising:
receive an indication of an airplane associated with a user;
receive an indication of flight data from one or more flight data repositories based on the indication of the indicated airplane;
identify one or more airports based on the flight data;
generate a flight path based on the identified one or more airports, the flight data, and the indicated airplane;
receive an indication of descriptive data regarding the flight path;
cause a display to visually display a pattern showing an indication of the flight path and an indication of the descriptive data to the user on a first user device; and
cause the flight path and the descriptive data to be transmitted to a second user device.
